(19) United States
(12) Patent Application Publication
(10) Pub. No.: US 2026/0206066 A1
(43) Pub. Date: Jul. 16, 2026

(54) RANDOM ACCESS CHANNEL CONFIGURATIONS FOR CANDIDATE CELL SWITCHING

(71) Applicant: QUALCOMM Incorporated, San Diego, CA (US)

(72) Inventors: Fang YUAN, Beijing (CN); Yan ZHOU, San Diego, CA (US)

(21) Appl. No.: 19/135,757

(22) PCT Filed: Jan. 20, 2023
(86) PCT No.: PCT/CN2023/073353

§ 371 Date: Jun. 4, 2025

(51) Int. Cl. H04W 74/0833; H04W 76/38

(52) U.S. Cl. CPC H04W 74/0833; H04W 76/38

(57) ABSTRACT

Methods, systems, and devices for wireless communications are described. A user equipment (UE) may receive, via a serving cell served by a network entity, a first control message that indicates a first random access channel (RACH) configuration associated with a candidate cell and a second RACH configuration associated with the candidate cell. In some examples, the UE may use the first RACH configuration to communicate via the candidate cell before a switch to the candidate cell and may use the second RACH configuration to communicate via the candidate cell after the switch. Before the switch, the UE may transmit, in association with obtaining timing advance information associated with the candidate cell, a first RACH message via the candidate cell in accordance with the first RACH configuration. After the switch, the UE may transmit a second RACH message via the candidate cell in accordance with the second RACH configuration.

### CROSS REFERENCE

The present Application is a 371 national stage filing of International PCT Application No. PCT/CN2023/073353 by YUAN et al. entitled “RANDOM ACCESS CHANNEL CONFIGURATIONS FOR CANDIDATE CELL SWITCHING,” filed Jan. 20, 2023, which is assigned to the assignee hereof, and which is expressly incorporated by reference in its entirety herein.

### FIELD OF TECHNOLOGY

The following relates to wireless communications, including random access channel (RACH) configurations for candidate cell switching.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some wireless communications systems may support UE mobility for cell switching. However, UE mobility via the communication of lower layer signaling may be unsupported.

### SUMMARY

The described techniques relate to improved methods, systems, devices, and apparatuses that support random access channel (RACH) configurations for candidate cell switching. For example, the described techniques support candidate RACH configurations for low latency and efficient communication of signaling in association with cell switching. For instance, a first network entity associated with a serving cell of a UE may configure the UE with a first RACH configuration and a second RACH configuration that are associated with a candidate cell for cell switching. In some examples, the UE may use the first RACH configuration to communicate via the candidate cell before a switch to the candidate cell, for example, such that timing advance information associated with the candidate cell may be obtained. The UE may use the second RACH configuration to communicate via the candidate cell after the switch to the candidate cell (e.g., after the candidate cell becomes the new serving cell for the UE), for example, such that an initial access procedure associated with the candidate cell may be performed.

The first RACH configuration may at least indicate the exclusion of a random access response (RAR) window, as timing advance information associated with the candidate cell based on a before-switch RACH message may be indicated to the UE via a command to switch to the candidate cell. The second RACH configuration may include a RAR window configuration to support the reception of a RAR (e.g., a msg2, a msgB) by the UE, for example, to support initial access by the UE after switching to the candidate cell, among other RACH processes. Thus, latency, resource usage, and power consumption associated with monitoring a RAR window before the cell switch may be avoided while supporting initial access by the UE after the cell switch.

A method for wireless communication at a UE is described. The method may include receiving, via a serving cell associated with the UE, a first control message indicating a first RACH configuration and a second RACH configuration that are associated with a candidate cell, the first RACH configuration for the UE to use to communicate via the candidate cell before a switch to the candidate cell, the second RACH configuration for the UE to use to communicate via the candidate cell after the switch to the candidate cell, receiving a second control message indicating that the UE is to perform a RACH procedure to obtain timing advance information associated with the candidate cell, transmit, before the switch to the candidate cell and based on the second control message, a first RACH message via the candidate cell in accordance with the first RACH configuration, and transmit, after performing the switch to the candidate cell and based on the timing advance information, a second RACH message via the candidate cell in accordance with the second RACH configuration.

An apparatus for wireless communication is described. The apparatus may include a memory, a transceiver, and at least one processor of a UE, the at least one processor coupled with the memory and the transceiver. The at least one processor may be configured to receive, via a serving cell associated with the UE, a first control message indicating a first RACH configuration and a second RACH configuration that are associated with a candidate cell, the first RACH configuration for the UE to use to communicate via the candidate cell before a switch to the candidate cell, the second RACH configuration for the UE to use to communicate via the candidate cell after the switch to the candidate cell, receive a second control message indicating that the UE is to perform a RACH procedure to obtain timing advance information associated with the candidate cell, transmit, before the switch to the candidate cell and based on the second control message, a first RACH message via the candidate cell in accordance with the first RACH configuration, and transmit, after performing the switch to the candidate cell and based on the timing advance information, a second RACH message via the candidate cell in accordance with the second RACH configuration.

Another apparatus for wireless communication at a UE is described. The apparatus may include means for receiving, via a serving cell associated with the UE, a first control message indicating a first RACH configuration and a second RACH configuration that are associated with a candidate cell, the first RACH configuration for the UE to use to communicate via the candidate cell before a switch to the candidate cell, the second RACH configuration for the UE to use to communicate via the candidate cell after the switch to the candidate cell, means for receiving a second control message indicating that the UE is to perform a RACH procedure to obtain timing advance information associated with the candidate cell, means for transmit, before the switch to the candidate cell and based on the second control message, a first RACH message via the candidate cell in accordance with the first RACH configuration, and means for transmit, after performing the switch to the candidate cell and based on the timing advance information, a second RACH message via the candidate cell in accordance with the second RACH configuration.

A non-transitory computer-readable medium storing code for wireless communication at a UE is described. The code may include instructions executable by a processor to receive, via a serving cell associated with the UE, a first control message indicating a first RACH configuration and a second RACH configuration that are associated with a candidate cell, the first RACH configuration for the UE to use to communicate via the candidate cell before a switch to the candidate cell, the second RACH configuration for the UE to use to communicate via the candidate cell after the switch to the candidate cell, receive a second control message indicating that the UE is to perform a RACH procedure to obtain timing advance information associated with the candidate cell, transmit, before the switch to the candidate cell and based on the second control message, a first RACH message via the candidate cell in accordance with the first RACH configuration, and transmit, after performing the switch to the candidate cell and based on the timing advance information, a second RACH message via the candidate cell in accordance with the second RACH configuration.

Some examples of the method, apparatuses, and non-transitory computer-readable medium described herein may further include operations, features, means, or instructions for receiving, via the serving cell or the candidate cell, a third control message indicating that the UE may be to perform the switch to the candidate cell, the third control message indicating the timing advance information associated with the candidate cell.

Some examples of the method, apparatuses, and non-transitory computer-readable medium described herein may further include operations, features, means, or instructions for performing the switch to the candidate cell after transmitting the first RACH message and before transmitting the second RACH message, where the second RACH message may be communicated in accordance with the second RACH configuration based on performing the switch.

In some examples of the method, apparatuses, and non-transitory computer-readable medium described herein, the first RACH configuration and the second RACH configuration may be included within a RACH configuration associated with the serving cell.

In some examples of the method, apparatuses, and non-transitory computer-readable medium described herein, the first RACH configuration includes a first physical RACH (PRACH) configuration associated with the candidate cell, a first RACH parameter configuration associated with the candidate cell, and a first RAR window configuration associated with the candidate cell, the first RAR window configuration indicating an exclusion of a RAR window associated with the first RACH message and the second RACH configuration includes a second PRACH configuration associated with the candidate cell, a second RACH parameter configuration associated with the candidate cell, and a second RAR window configuration associated with the candidate cell.

In some examples of the method, apparatuses, and non-transitory computer-readable medium described herein, the first RACH configuration and the second RACH configuration may be included within a same PRACH configuration associated with the candidate cell, the first RACH configuration includes a first RACH parameter configuration associated with the candidate cell and a first RAR window configuration associated with the candidate cell, the first RAR window configuration indicating an exclusion of a RAR window associated with the first RACH message, and the second RACH configuration includes a second RACH parameter configuration associated with the candidate cell and a second RAR window configuration associated with the candidate cell.

In some examples of the method, apparatuses, and non-transitory computer-readable medium described herein, the first RACH configuration and the second RACH configuration may be included within a same PRACH configuration associated with the candidate cell and a same RACH parameter configuration associated with the candidate cell, the first RACH configuration includes a first RAR window configuration associated with the candidate cell, the first RAR window configuration indicating an exclusion of a RAR window associated with the first RACH message, and the second RACH configuration includes a second RAR window configuration associated with the candidate cell.

In some examples of the method, apparatuses, and non-transitory computer-readable medium described herein, the first RACH configuration and the second RACH configuration may be included within a RACH configuration associated with the candidate cell, the first RACH configuration includes a first RAR window configuration associated with the candidate cell, the first RAR window configuration indicating an exclusion of a RAR window associated with the first RACH message, and the second RACH configuration includes a second RAR window configuration associated with the candidate cell.

In some examples of the method, apparatuses, and non-transitory computer-readable medium described herein, the first RACH configuration may be included within a RACH configuration associated with the serving cell and includes a first RAR window configuration associated with the candidate cell, the first RAR window configuration indicating an exclusion of a RAR window associated with the first RACH message and the second RACH configuration may be included within a RACH configuration associated with the candidate cell and includes a second RAR window configuration associated with the candidate cell.

In some examples of the method, apparatuses, and non-transitory computer-readable medium described herein, receiving the second control message may include operations, features, means, or instructions for receiving the second control message via the serving cell or via the candidate cell.

In some examples of the method, apparatuses, and non-transitory computer-readable medium described herein, the first RACH configuration and the second RACH configuration include an identifier associated with the candidate cell.

A method for wireless communication at a network entity is described. The method may include transmitting, via a serving cell associated with a UE, a first control message indicating a first RACH configuration and a second RACH configuration that are associated with a candidate cell, the first RACH configuration for the UE to use to communicate via the candidate cell before a switch to the candidate cell, the second RACH configuration for the UE to use to communicate via the candidate cell after the switch to the candidate cell and transmitting, via the serving cell, a second control message indicating that the UE is to perform, based on the first RACH configuration, a RACH procedure to obtain timing advance information associated with the candidate cell.

An apparatus for wireless communication is described. The apparatus may include a memory and at least one processor of a network entity, the at least one processor coupled with the memory. The at least one processor may be configured to transmit, via a serving cell associated with a UE, a first control message indicating a first RACH configuration and a second RACH configuration that are associated with a candidate cell, the first RACH configuration for the UE to use to communicate via the candidate cell before a switch to the candidate cell, the second RACH configuration for the UE to use to communicate via the candidate cell after the switch to the candidate cell and transmit, via the serving cell, a second control message indicating that the UE is to perform, based on the first RACH configuration, a RACH procedure to obtain timing advance information associated with the candidate cell.

Another apparatus for wireless communication at a network entity is described. The apparatus may include means for transmitting, via a serving cell associated with a UE, a first control message indicating a first RACH configuration and a second RACH configuration that are associated with a candidate cell, the first RACH configuration for the UE to use to communicate via the candidate cell before a switch to the candidate cell, the second RACH configuration for the UE to use to communicate via the candidate cell after the switch to the candidate cell and means for transmitting, via the serving cell, a second control message indicating that the UE is to perform, based on the first RACH configuration, a RACH procedure to obtain timing advance information associated with the candidate cell.

A non-transitory computer-readable medium storing code for wireless communication at a network entity is described. The code may include instructions executable by a processor to transmit, via a serving cell associated with a UE, a first control message indicating a first RACH configuration and a second RACH configuration that are associated with a candidate cell, the first RACH configuration for the UE to use to communicate via the candidate cell before a switch to the candidate cell, the second RACH configuration for the UE to use to communicate via the candidate cell after the switch to the candidate cell and transmit, via the serving cell, a second control message indicating that the UE is to perform, based on the first RACH configuration, a RACH procedure to obtain timing advance information associated with the candidate cell.

Some examples of the method, apparatuses, and non-transitory computer-readable medium described herein may further include operations, features, means, or instructions for transmitting, via the serving cell, a third control message indicating that the UE may be to perform, based on the second RACH configuration, the switch to the candidate cell, the third control message indicating the timing advance information associated with the candidate cell.

In some examples of the method, apparatuses, and non-transitory computer-readable medium described herein, the first RACH configuration and the second RACH configuration may be included within a RACH configuration associated with the serving cell.

In some examples of the method, apparatuses, and non-transitory computer-readable medium described herein, the first RACH configuration includes a first PRACH configuration associated with the candidate cell, a first RACH parameter configuration associated with the candidate cell, and a first RAR window configuration associated with the candidate cell, the first RAR window configuration indicating an exclusion of a RAR window associated with the first RACH configuration and the second RACH configuration includes a second PRACH configuration associated with the candidate cell, a second RACH parameter configuration associated with the candidate cell, and a second RAR window configuration associated with the candidate cell.

In some examples of the method, apparatuses, and non-transitory computer-readable medium described herein, the first RACH configuration and the second RACH configuration may be included within a same PRACH configuration associated with the candidate cell, the first RACH configuration includes a first RACH parameter configuration associated with the candidate cell and a first RAR window configuration associated with the candidate cell, the first RAR window configuration indicating an exclusion of a RAR window associated with the first RACH configuration, and the second RACH configuration includes a second RACH parameter configuration associated with the candidate cell and a second RAR window configuration associated with the candidate cell.

In some examples of the method, apparatuses, and non-transitory computer-readable medium described herein, the first RACH configuration and the second RACH configuration may be included within a same PRACH configuration associated with the candidate cell and a same RACH parameter configuration associated with the candidate cell, the first RACH configuration includes a first RAR window configuration associated with the candidate cell, the first RAR window configuration indicating an exclusion of a RAR window associated with the first RACH configuration, and the second RACH configuration includes a second RAR window configuration associated with the candidate cell.

In some examples of the method, apparatuses, and non-transitory computer-readable medium described herein, the first RACH configuration and the second RACH configuration may be included within a RACH configuration associated with the candidate cell, the first RACH configuration includes a first RAR window configuration associated with the candidate cell, the first RAR window configuration indicating an exclusion of a RAR window associated with the first RACH configuration, and the second RACH configuration includes a second RAR window configuration associated with the candidate cell.

In some examples of the method, apparatuses, and non-transitory computer-readable medium described herein, the first RACH configuration may be included within a RACH configuration associated with the serving cell and includes a first RAR window configuration associated with the candidate cell, the first RAR window configuration indicating an exclusion of a RAR window associated with the first RACH configuration and the second RACH configuration may be included within a RACH configuration associated with the candidate cell and includes a second RAR window configuration associated with the candidate cell.

In some examples of the method, apparatuses, and non-transitory computer-readable medium described herein, the first RACH configuration and the second RACH configuration include an identifier associated with the candidate cell.

### BRIEF DESCRIPTION OF THE DRAWINGS

FIGS. 1 and 2 illustrate examples of wireless communications systems that support random access channel (RACH) configurations for candidate cell switching in accordance with one or more aspects of the present disclosure.

FIGS. 3, 4, and 5 illustrate examples of configuration diagrams that support RACH configurations for candidate cell switching in accordance with one or more aspects of the present disclosure.

FIGS. 6 and 7 illustrate block diagrams of devices that support RACH configurations for candidate cell switching in accordance with one or more aspects of the present disclosure.

FIG. 8 illustrates a block diagram of a communications manager that supports RACH configurations for candidate cell switching in accordance with one or more aspects of the present disclosure.

FIG. 9 illustrates a diagram of a system including a device that supports RACH configurations for candidate cell switching in accordance with one or more aspects of the present disclosure.

FIGS. 10 and 11 illustrate block diagrams of devices that support RACH configurations for candidate cell switching in accordance with one or more aspects of the present disclosure.

FIG. 12 illustrates a block diagram of a communications manager that supports RACH configurations for candidate cell switching in accordance with one or more aspects of the present disclosure.

FIG. 13 illustrates a diagram of a system including a device that supports RACH configurations for candidate cell switching in accordance with one or more aspects of the present disclosure.

FIGS. 14 through 18 illustrate flowcharts showing methods that support RACH configurations for candidate cell switching in accordance with one or more aspects of the present disclosure.

### DETAILED DESCRIPTION

Some wireless communications systems may support inter-cell mobility, such that a user equipment (UE) may be switch from a serving cell (e.g., a source cell) to a candidate cell (e.g., a target cell), for example, as the UE moves. In some cases, such cell switching (e.g., cell handover) may be supported via the communication of higher layer signaling, such as layer 3 (L3) signaling. Expansion of cell switching to be facilitated via lower layer signaling, such as layer 1 (L1) and/or layer 2 (L2) signaling, may include the communication of random access channel (RACH) signaling. For example, the UE may transmit a RACH message to a network entity serving a candidate cell such that timing advance information associated with the candidate cell may be measured and obtained. However, RACH configurations to support such RACH signaling may be non-existent.

Additionally, RACH communications before and after a cell switch may serve different purposes. For instance, before a switch to a candidate cell, a UE may transmit a RACH message in association with obtaining timing advance information for the candidate cell such that switching to the candidate cell may be supported. A RACH procedure performed after the cell switch may support initial access by the UE, among other RACH processes. Thus, in some cases, a general RACH configuration for communicating via the candidate cell both before and after a switch to the candidate cell may be resource inefficient and increase a latency of the switch, among other disadvantages.

In accordance with examples described herein, a first network entity associated with a serving cell of a UE may configure the UE with various RACH configurations that support low latency and efficient communication of RACH signaling in association with cell switching. For example, the first network entity may transmit a first control message that indicates a first RACH configuration and a second RACH configuration that are associated with a candidate cell for cell switching. The first RACH configuration may be a relatively simplified RACH configuration that supports the obtainment of timing advance information associated with the candidate cell. For example, in some cases, the first RACH configuration may be used to support a RACH procedure performed before a switch to the candidate cell to obtain the timing advance information. The first RACH configuration may at least indicate the exclusion of a random access response (RAR) window to reduce latency and resource usage associated with transmitting a before-switch RACH message (e.g., a RACH preamble), as the timing advance information based on the before-switch RACH message may be indicated to the UE via a command to switch to the candidate cell (which may be referred to as a cell switch command).

Thus, a RAR transmitted via the candidate cell may be unnecessary and resources typically allocated for the RAR window may be saved, thereby increasing resource usage efficiency. Additionally, latency associated with cell switching may be reduced, for example, by eliminating the monitoring of the RAR window and the transmission of a separate message to indicate the timing advance information. Further, power consumption associated with monitoring the RAR window by the UE may be eliminated, thereby increasing power savings at the UE.

The second RACH configuration may be a full (e.g., regular) RACH configuration that supports initial access RACH procedures via the candidate cell, among other RACH processes, such as Radio Resource Control (RRC) re-establishment, traffic arrival when uplink synchronization status non-synchronized, RRC inactive state transition, time alignment establishment at a secondary cell, system information request, or beam failure recovery, among others. For example, the second RACH configuration may include a RAR window configuration to support the reception of a RAR (e.g., a msg2, a msgB) by the UE, among other potential differences between the first and second RACH configurations, as described herein. Accordingly, in some examples, the UE may perform an initial access RACH procedure via the candidate cell in accordance with the second RACH configuration after switching to the candidate cell, for example, without waiting to receive system information via the candidate cell that includes the second RACH configuration.

Aspects of the disclosure are initially described in the context of wireless communications systems. Aspects of the disclosure are additionally described in the context of configuration diagrams. Aspects of the disclosure are further illustrated by and described with reference to apparatus diagrams, system diagrams, and flowcharts that relate to RACH configurations for candidate cell switching.

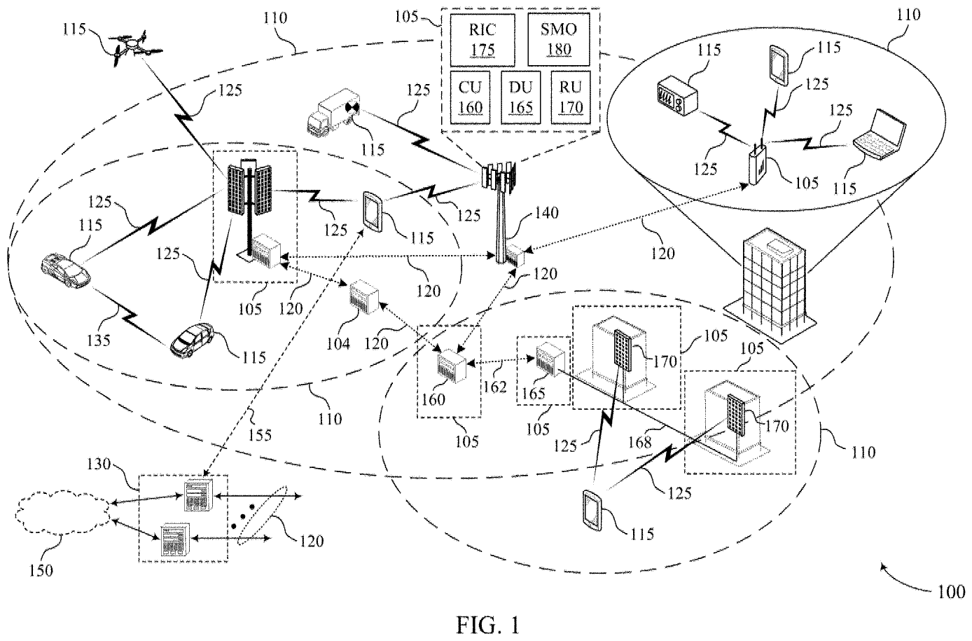

FIG. 1 illustrates an example of a wireless communications system 100 that supports RACH configurations for candidate cell switching in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support RACH configurations for candidate cell switching as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The wireless communications system 100 may support inter-cell mobility by a UE 115. For example, the UE 115 may transition from a serving cell to a candidate cell (e.g., a target cell) via which the UE 115 may communicate with a corresponding network entity 105. In some examples, the UE 115 may be moving into a coverage area 110 associated with the candidate cell, or the candidate cell (e.g., a serving network entity 105 of the candidate cell) may be capable of providing better service for the UE 115 or relieving the serving cell of excess load. In some cases, the transition may be referred to as a “handover.”

In accordance with examples described herein, the wireless communications system 100 may support handover of a UE 115 via lower layer signaling, such as L1 and/or L2 signaling. For example, as part of handover of the UE 115 from a serving cell to a candidate cell, timing advance information associated with the candidate cell may be obtained before the UE 115 transitions (e.g., switches) to the candidate cell. The UE 115 may be configured with a first RACH configuration (e.g., a simplified RACH configuration) that may be used in association with obtaining the timing advance information. For example, the UE 115 may transmit, in accordance with the first RACH configuration, a RACH message via the candidate cell based on which the timing advance information may be measured and obtained. The UE 115 may obtain the timing advance information via a subsequently transmitted cell switch indication that indicates for the UE 115 to switch to candidate cell. As such, the first RACH configuration may indicate for the exclusion of a RAR window corresponding to the RACH message, thereby eliminating latency, power consumption, and resource usage associated with monitoring and/or communicating during the RAR window.

The UE 115 may also be configured with a second RACH configuration (e.g., a regular RACH configuration) that may be used for initial access with the candidate cell, among other RACH processes. For example, after switching to the candidate cell based on the cell switch indication, the UE 115 may communicate one or more RACH messages in accordance with the second RACH configuration as part of an initial access procedure with the candidate cell. The second RACH configuration may include a configuration of a RAR window during which a RAR (e.g., a msg2, a msgB) may be communicated as part of the initial access procedure.

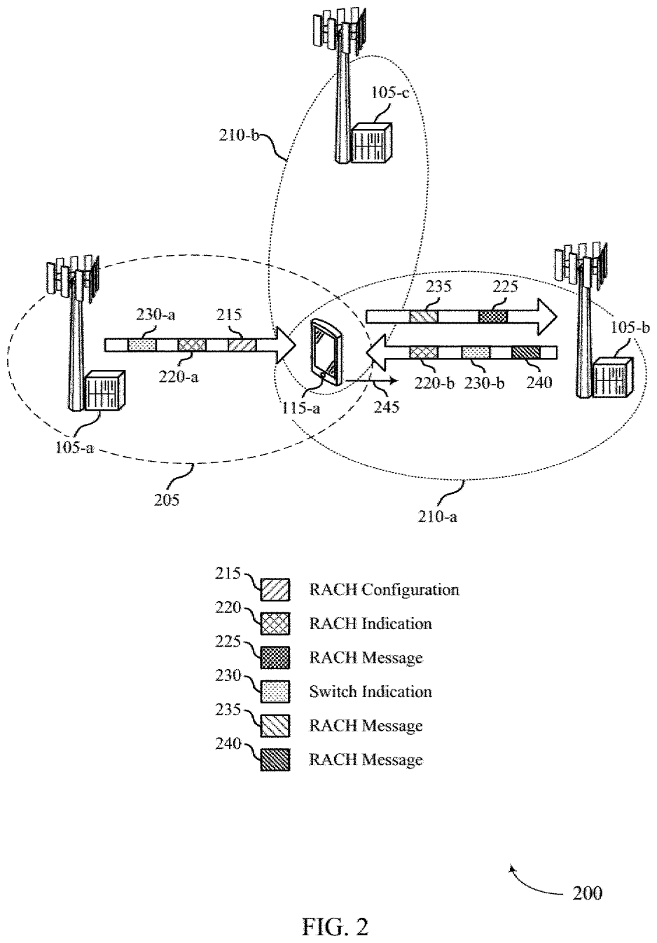

FIG. 2 illustrates an example of a wireless communications system 200 that supports RACH configurations for candidate cell switching in accordance with one or more aspects of the present disclosure. The wireless communications system 200 may implement or be implemented by aspects of the wireless communications system 100, as described with reference to FIG. 1. For example, the wireless communications system 200 may include network entities 105 and a UE 115-a, which may be examples of the corresponding devices described herein, including with reference to FIG. 1.

The wireless communications system 200 may support communications between the UE 115-a and the network entities 105. In the example of FIG. 2, a network entity 105-a may be associated with (e.g., serve) a cell 205 that is associated with a coverage area (e.g., a coverage area 110) supported by the network entity 105-a. The cell 205 may be an example of a serving cell of the UE 115-a.

The UE 115-a may also be within a coverage area of one or more cells 210 supported by one or more other network entities 105. For example, the wireless communications system 200 may include a network entity 105-b and a network entity 105-c that support a cell 210-a and a cell 210-b, respectively. The cells 210 may be examples of candidate cells to which the UE 115-a may switch to function as the serving cell of the UE 115-a and may be referred to as candidate cells 210. For example, the UE 115-a may perform a handover procedure to switch to a candidate cell 210 for various reasons, such as to obtain better service for the UE 115-a relative to the serving cell 205, to relieve the serving cell 205 of excess load, based on a movement 245 of the UE 115-a into a respective coverage area of the candidate cell 210, or a combination thereof, among other reasons.

The wireless communications system 200 may support L1/L2-supported (e.g., triggered) mobility for the UE 115-a. That is, the UE 115-a may switch to a candidate cell 210 based on the communication of L1 and/or L2 signaling (e.g., rather than higher layer signaling, such as layer 3 (L3) signaling). To support such switching to a candidate cell 210 (e.g., the candidate cell 210-a), the UE 115-a may communicate RACH signaling according to various RACH configurations. For example, the network entity 105-a may transmit, via the serving cell 205, a RACH configuration 215 (e.g., a control message that includes the RACH configuration 215) to the UE 115-a. The RACH configuration 215 may include a first RACH configuration and a second RACH configuration that are associated with the candidate cell 210-a. For example, the UE 115-a may use the first RACH configuration and the second RACH configuration to communicate RACH messages via the candidate cell. In some examples, the UE 115-a may be similarly configured with respective first and second RACH configurations that are associated with the candidate cell 210-b. In other words, the UE 115-a may be configured with (e.g., via respective RACH configurations 215) respective first and second RACH configurations per candidate cell 210.

The first and second RACH configurations may be used in association with cell switching. For example, as part of handover to the candidate cell 210-a, various measurements associated with the candidate cell 210-a may be performed, for example, to determine whether to perform the handover and/or determine parameters for performing the handover. One of the measurements performed may include a timing advance measurement to determine timing advance information associated with communicating via the candidate cell 210-a. The UE 115-a may perform a RACH procedure (e.g., transmit a RACH message, such as a RACH preamble) in association with obtaining the timing advance information and may use the first RACH configuration to do so.

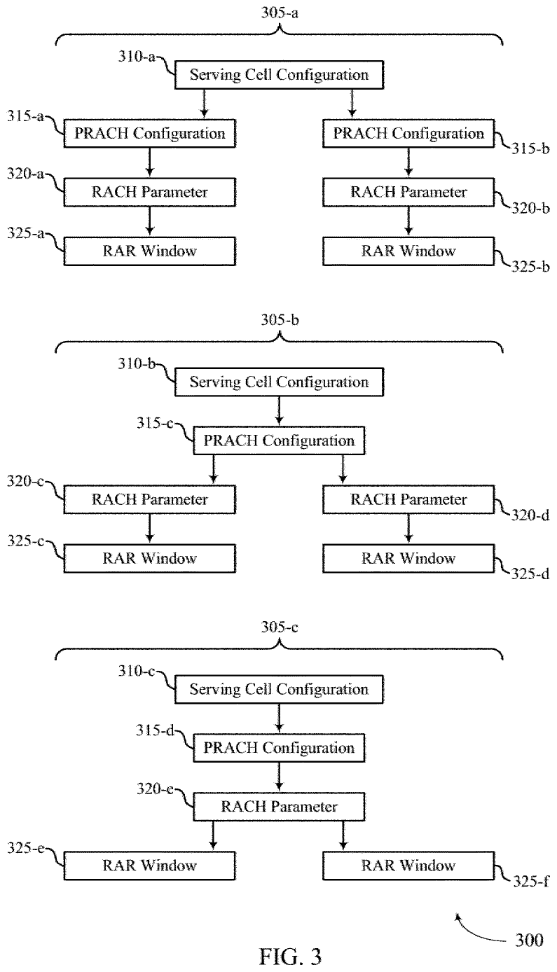

For example, the network entity 105-a may transmit a RACH indication 220-a to the UE 115-a via the serving cell 205. Alternatively, the network entity 105-b may transmit a RACH indication 220-b to the UE 115-a via the candidate cell 210-a. A RACH indication 220 may indicate (e.g., trigger, order) the UE 115-a to perform a first RACH procedure to obtain the timing advance information associated with the candidate cell 210-a. In some examples, the RACH indication 220 may include one or more identifiers associated with one or more candidate cells 210, for example, to perform respective first RACH procedures via the indicated candidate cells 210. In some examples, the RACH indication 220 may be communicated via a physical downlink control channel (PDDCH), and the corresponding RACH procedure may be referred to as a PDCCH-ordered RACH procedure for the candidate cell 210-a (e.g., and other candidate cells 210, if indicated). To perform the first RACH procedure, the UE 115-a may transmit a RACH message 225, such as a RACH preamble, to the network entity 105-b via the candidate cell 210-a. The UE 115-a may transmit the RACH message 225 in accordance with communication parameters included in the first RACH configuration, as described with reference to FIG. 3.

The network entity 105-b may receive the RACH message 225 and determine timing advance information based on the RACH message 225. For example, the network entity 105-b may calculate the timing advance information for communicating with the UE 115-a via the candidate cell based on one or more measurements of the RACH message 225, such as a propagation delay of the RACH message 225, among others.

The UE 115-a may receive an indication of the timing advance information via a switch indication 230. For example, the network entity 105-a may transmit, via the serving cell 205, a switch indication 230-a to the UE 115-a that indicates (e.g., triggers, orders) the UE 115-a to switch to the candidate cell 210-a. The switch indication 230-a may include the timing advance information according to which the UE 115-a may communicate with the network entity 105-b via the candidate cell 210-a. Here, the network entity 105-a may receive an indication of the timing advance information from the network entity 105-b (e.g., via a backhaul link 120) for inclusion in the switch indication 230-a. Alternatively, the network entity 105-b may transmit a switch indication 230-b via the candidate cell 210-a. Similarly, the switch indication 230-b may indicate the UE 115-a to switch to the candidate cell 210-a and may include the timing advance information.

Because the first RACH configuration may be used to obtain timing advance information (e.g., rather than to perform an initial access procedure), the first RACH configuration may be a relatively simplified RACH configuration relative to the second RACH configuration. For example, because the timing advance information is indicated via a switch indication 230, communication of additional RACH signaling beyond the RACH message 225 may be unnecessary as part of the first RACH procedure. For instance, it may be unnecessary for the network entity 105-b to transmit a RAR in response to the RACH message 225 (e.g., a msg2 of a 4-step RACH procedure, a msgB of a 2-step RACH procedure) as the timing advance information may be indicated via the switch indication 230 and the first RACH procedure may not be performed for the purposes of initial access. As such, the first RACH configuration may include a RAR window configuration (e.g., the first RACH configuration may exclude a RAR window configuration) that indicates an exclusion of a RAR window in response to the RACH message 225.

In response to the switch indication 230, the UE 115-a may perform the switch to the candidate cell 210-a. After performing the switch to the candidate cell 210-a, the UE 115-a may perform a second RACH procedure via the candidate cell 210-a (e.g., which may now be the serving cell of the UE 115-a), for example, to support a RACH process, such as initial access to acquire uplink synchronization with the network entity 105-b and obtain a specific identifier for communicating with the network entity 105-b, RRC establishment or re-establishment, timing alignment, system information request, beam failure recovery, or a combination thereof, among other RACH processes. For example, the UE 115-a may transmit, as part of the second RACH procedure, a RACH message 235, such as a RACH preamble (e.g., a msg1 of a 4-step RACH procedure, a msgA of a 2-step RACH procedure). The UE 115-a may transmit the RACH message 235 in accordance with communication parameters included in the second RACH configuration, as described with reference to FIG. 3.

Because the second RACH configuration may be used for initial access, the second RACH configuration may include additional information relative to the first RACH configuration (e.g., may be a regular, full RACH configuration). For example, the second RACH procedure may include the transmission of one or more RACH messages 240 by the network entity 105-b to the UE 115-a to support the initial access. For instance, the network entity 105-b may transmit at least a RAR to the UE 115-a, and as such, the second RACH configuration may at least include a configuration for a RAR window during which the network entity 105-b and the UE 115-a may communicate the RAR. Additional details related to various options for candidate cell RACH configurations and the differences between the first and second RACH configuration are described below with reference to FIGS. 3 through 5.

In some examples, the first RACH configuration may be considered a “before-switch” RACH configuration associated with the candidate cell 210-a. That is, the UE 115-a may be configured to communicate RACH signaling (e.g., the RACH message 225) in accordance with the first RACH configuration before switching to the candidate cell 210-a (e.g., while the cell 205 is still the serving cell of the UE 115-a). Similarly, in some examples, the second RACH configuration may be considered an “after-switch” RACH configuration associated with the candidate cell 210-a. That is, the UE 115-a may be configured to communicate RACH signaling (e.g., RACH messages 235, 240) in accordance with the second RACH configuration after switching to the candidate cell 210-a (e.g., after the candidate cell 210-a becomes the serving cell of the UE 115-a).

By implementing before-switch and after-switch candidate cell RACH configurations in association with cell switching, cell switching latency may be reduced, power consumption may be reduced, and resource usage efficiency may be increased, among other benefits. For example, the exclusion of a RAR window in association with the first RACH procedure (e.g., a before-switch RACH procedure) may eliminate latency, power consumption, and resource usage associated with monitoring and/or communicating during the RAR window. Additionally, transmission of the timing advance information via the switch indication 230 may eliminate the transmission of a separate message to indicate the timing advance information, thereby reducing latency and increasing resource usage efficiency. Further, the configuration of the after-switch RACH configuration may enable the UE 115-a to perform the second RACH procedure (e.g., an after-switch RACH procedure) without waiting to receive such configuration information after the switch to the candidate cell 210-a (e.g., via system information transmitted by the network entity 105-b), thereby reducing a latency of after-switch connection procedures.

FIG. 3 illustrates an example of a configuration diagram 300 that supports RACH configurations for candidate cell switching in accordance with one or more aspects of the present disclosure. The configuration diagram 300 may be implemented by aspects of the wireless communications systems 100 or 200 as described with reference to FIGS. 1 and 2. For example, the configuration diagram 300 may be implemented by a UE 115 and one or more network entities 105, which may be examples of the corresponding devices described herein, including with reference to FIGS. 1 and 2. The configuration diagram 300 shows various configurations 305, which may be implemented to support low latency and efficient cell switching via lower layer signaling, among other benefits.

In the example of FIG. 3, the RACH configurations for candidate cells may be configured under a serving cell of the UE 115. For example, a network entity 105 associated with a serving cell of the UE 115 may configure the UE 115 with (e.g., via one or more RACH configurations 215) a first RACH configuration (e.g., before-switch RACH configuration) associated with a candidate cell for obtaining timing advance information associated with the candidate cell and a second RACH configuration (e.g., an after-switch RACH configuration) associated with the candidate cell for performing one or more RACH processes, such as initial access, among others. The first RACH configuration and the second RACH configuration may be included within a serving cell configuration 310 that includes a RACH configuration associated with (e.g., of) the serving cell.

In the example of configuration 305-a, two candidate cell RACH configurations may be configured per candidate cell. For example, within a serving cell configuration 310-a (e.g., and separate from a RACH configuration for communicating via the serving cell that is included within the serving cell configuration 310-a), the first RACH configuration may include a physical RACH (PRACH) configuration 315-a, a RACH parameter configuration 320-a, and a RAR window configuration 325-a. Separately, the second RACH configuration may include a PRACH configuration 315-b, a RACH parameter configuration 320-b, and a RAR window configuration 325-b. The RACH parameter configurations 320 may be included within the respective PRACH configurations 315, and the RAR window configurations 325 may be included within the respective RACH parameter configurations 320. Additionally, a respective PRACH configuration 315 may be considered a respective candidate cell RACH configuration, and thus, different PRACH configurations 315 included within the serving cell configuration 310-a may be considered different candidate cell RACH configurations.

A PRACH configuration 315 may include various parameters for performing RACH procedures via the candidate cell. For example, a PRACH configuration 315 may include a RACH parameter configuration 320 in addition to other parameters, such as total quantity of RACH preambles, a synchronization signal block (SSB) per RACH occasion parameter, a reference signal received power (RSRP) threshold, a msg1 subcarrier spacing, a msg3 transform precoder, among other parameters (e.g., parameters configured under a RACH-ConfigCommon configuration).

A RACH parameter configuration 320, which may be referred to as a RACH-ConfigGeneric configuration, may include a RAR window configuration 325 in addition to other communication parameters associated with RACH signaling, such as frequency information for PRACH (e.g., a frequency multiplexing factor, a msg1 frequency start, among other frequency information) and transmission power information for PRACH (e.g., a preambleReceivedTargetPower parameter, a powerRampingStep parameter, among other transmission power information).

A RAR window configuration 325, which may be referred to as an ra-ResponseWindow configuration, may include parameters of a RAR window that is triggered in response to a RACH message transmitted by the UE, such as a RACH preamble. For example, the RAR window configuration 325 may indicate a timing of the RAR window relative to the RACH preamble (e.g., a timing offset between the RACH preamble and RAR window), a duration of the RAR window, a frequency of the RAR window, among other RAR window parameters.

At least the RAR window configurations 325-a and 325-b may be different between the first RACH configuration and the second RACH configuration. For example, the first RACH configuration may be used to perform RACH procedures via the candidate cell before a switch to the candidate cell by the UE 115. As such, the RAR window configuration 325-a may indicate an exclusion of a RAR window in response to the transmission of a RACH preamble for the purposes of obtaining timing advance information associated with the candidate cell. In some examples, the first RACH configuration may indicate the exclusion of the RAR window by excluding the RAR window configuration 325-a. The RAR window configuration 325-b may instead include a configuration for a RAR window in response to the transmission of a RACH preamble (e.g., as part of initial access or other RACH process).

Other RACH parameters between the first RACH configuration and the second RACH configuration may be the same or different. For example, respective parameters of the PRACH configurations 315-a and 315-b, the RACH parameter configurations 320-a and 320-b, or a combination thereof, may be the same or different. Additionally, in some examples, the PRACH configurations 315-a and 315-b may each include an identifier associated with the candidate cell, for example, so as to support the identification of the candidate cell RACH configurations separate from the serving cell RACH configuration (e.g., and one or more other candidate cell RACH configurations for other candidate cells included within the serving cell configuration 310-a).

In some examples, the PRACH configuration 315-a (e.g., the RAR window configuration 325-a) may be a contention-free based RACH configuration. For example, the PRACH configuration 315-a may include an allocation of a RACH preamble to use, such that a contention-free RACH procedure may be performed in accordance with the PRACH configuration 315-a. The PRACH configuration 315-b may be a contention-based RACH configuration. For example, the PRACH configuration 315-b may exclude a specific indication of a RACH preamble to use, such that a contention-based RACH procedure may be performed in accordance with the PRACH configuration 315-a.

In the example of configuration 305-b, one candidate cell RACH configuration may be configured per candidate cell, and the first and second RACH configurations for the candidate cell may be separated at the RACH parameter configuration 320 level. For example, the serving cell configuration 310-b may include a single PRACH configuration 315-c associated with the candidate cell. The PRACH configuration 315-c may include a RACH parameter configuration 320-c and a RAR window configuration 325-c corresponding to the first RACH configuration (e.g., for use before a switch to the candidate cell). The PRACH configuration 315-c may also include a RACH parameter configuration 320-d and a RAR window configuration 325-d corresponding to the second RACH configuration (e.g., for use after the switch to the candidate cell). That is, the first and second RACH configuration may be included within a same PRACH configuration 315.

Similar to the configuration 305-a, at least the RAR window configuration 325-c and the RAR window configuration 325-d may be different. For example, the RAR window configuration 325-c may indicate the exclusion of a RAR window, and the RAR window configuration 325-d may indicate the inclusion of a RAR window. Additionally, the first and second RACH configurations may share the same parameters included under the PRACH configuration 315-c, however, respective parameters of the RACH parameter configurations 320-b and 320-d may be the same or different.

In the example of configuration 305-c, one candidate cell RACH configuration may be configured per candidate cell, and the first and second RACH configurations for the candidate cell may be separated at the RAR window configuration 325 level. For example, the serving cell configuration 310-c may include a single PRACH configuration 315-d associated with the candidate cell that includes a single RACH parameter configuration 320-e. The RACH parameter configuration 320-e may include a RAR window configuration 325-e corresponding to the first RACH configuration (e.g., for use before a switch to the candidate cell) and a RAR window configuration 325-f corresponding to the second RACH configuration (e.g., for use after the switch to the candidate cell). That is, the first and second RACH configurations may be included within a same RACH parameter configuration 320. For the configuration 305-c, the RAR window configuration 325-e and the RAR window configuration 325-f may be different (e.g., indicating the exclusion and inclusion of a RAR window, respectively), while the first and second RACH configurations may share the same parameters included under the PRACH configuration 315-d and the RACH parameter configuration 320-e.

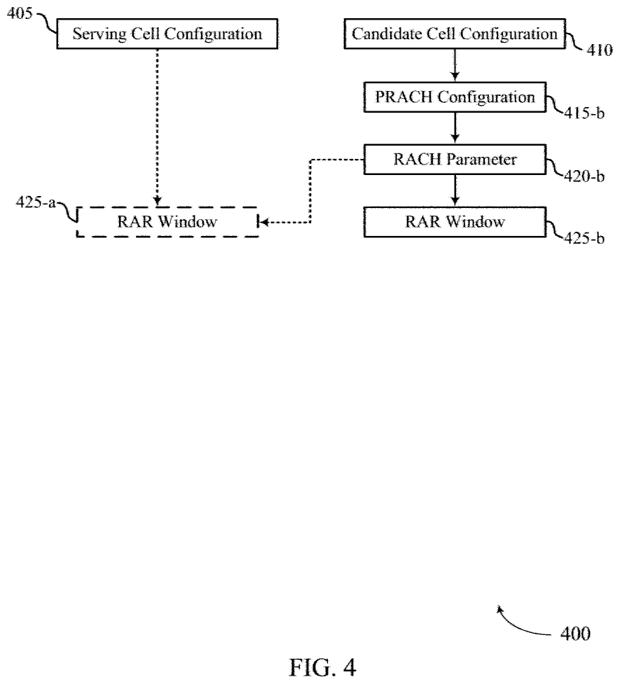

FIG. 4 illustrates an example of a configuration diagram 400 that supports RACH configurations for candidate cell switching in accordance with one or more aspects of the present disclosure. The configuration diagram 400 may be implemented by aspects of the wireless communications systems 100 or 200 as described with reference to FIGS. 1 and 2. For example, the configuration diagram 400 may be implemented by a UE 115 and one or more network entities 105, which may be examples of the corresponding devices described herein, including with reference to FIGS. 1 and 2. The configuration diagram 400 shows RACH configurations, which may be implemented to support low latency and efficient cell switching via lower layer signaling, among other benefits.

In the example of FIG. 4, RACH configurations for a candidate cell may be configured under the candidate cell. For example, a network entity 105 associated with a serving cell of the UE 115 may configure the UE with a serving cell configuration 405 that includes a RACH configuration (e.g., a PRACH configuration) for performing RACH procedures via the serving cell. The network entity may further configure the UE 115 (e.g., via one or more RACH configurations 215) with a candidate cell configuration 410 for performing RACH procedures via the candidate cell. The candidate cell configuration 410 may be a separate RACH configuration from the serving cell configuration 405 and may include an identifier associated with the candidate cell, for example, so as to differentiate the serving cell configuration 405 from the candidate cell configuration 410.

The candidate cell configuration 410 may include a first RACH configuration (e.g., before-switch RACH configuration) associated with the candidate cell and a second RACH configuration (e.g., an after-switch RACH configuration) associated with the candidate cell, as described herein. The candidate cell configuration 410 may include one or more PRACH configurations 415-b, which may be examples of a PRACH configuration 315. The candidate cell configuration 410 may also include one or more RACH parameters configuration 420-b, which may be examples of a RACH parameter configuration 320. The candidate cell configuration 410 may also include one or more RAR window configurations 425-b, which may be examples of a RAR window configuration 325.

At least the RAR window configurations 425 may be different between the first RACH configuration and the second RACH configuration. For example, the first RACH configuration may include a RAR window configuration 425 that indicates an exclusion of a RAR window in response to the transmission of a RACH preamble for the purposes of obtaining timing advance information associated with the candidate cell. For instance, the candidate cell configuration 410 may include a single RAR window configuration 425-b, and the first RACH configuration may indicate that the RAR window configuration 425-b may be ignored, such that no RAR window is included (e.g., in association with before-switch RACH procedures). The second RACH configuration may indicate that the RAR window configuration 425-b of the candidate cell configuration 410 may be used (e.g., in association with after-switch RACH procedures). In some examples, the first RACH configuration may indicate that a RAR window configuration 425-a of the serving cell configuration 405 may be used, for example, in association with before-switch RACH procedures.

In some examples, the first and second RACH configurations may be included within same or different PRACH configurations 315-b, same or different RACH parameter configurations 420-b, or a combination thereof, as described with reference to FIG. 3.

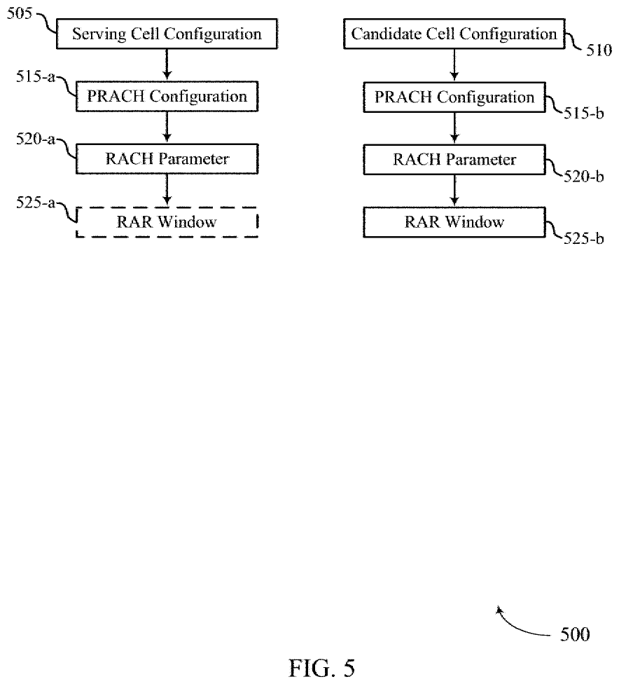

FIG. 5 illustrates an example of a configuration diagram 500 that supports RACH configurations for candidate cell switching in accordance with one or more aspects of the present disclosure. The configuration diagram 500 may be implemented by aspects of the wireless communications systems 100 or 200 as described with reference to FIGS. 1 and 2. For example, the configuration diagram 500 may be implemented by a UE 115 and one or more network entities 105, which may be examples of the corresponding devices described herein, including with reference to FIGS. 1 and 2. The configuration diagram 500 shows RACH configurations, which may be implemented to support low latency and efficient cell switching via lower layer signaling, among other benefits.

In the example of FIG. 5, two RACH configurations may be configured per candidate cell, with one RACH configuration be included under a serving cell, and one RACH configuration being included under the candidate cell. For example, a network entity 105 associated with a serving cell of the UE 115 may configure the UE with a serving cell configuration 505 that includes a RACH configuration (e.g., a PRACH configuration) for performing RACH procedures via the serving cell. The network entity may further configure the UE 115 with a candidate cell configuration 510 for performing RACH procedures via the candidate cell. The candidate cell configuration 510 may be a separate RACH configuration from the serving cell configuration 505 and may include an identifier associated with the candidate cell, for example, so as to differentiate the serving cell configuration 505 from the candidate cell configuration 510.

The serving cell configuration 505 may also include a first RACH configuration (e.g., before-switch RACH configuration) associated with the candidate cell for obtaining timing advance information associated with the candidate cell. For example, a network entity 105 associated with a serving cell of the UE 115 may configure the UE 115 with (e.g., via one or more RACH configurations 215) the first RACH configuration and a second RACH configuration (e.g., an after-switch RACH configuration) associated with the candidate cell for performing one or more RACH processes, such as initial access, among others. The first RACH configuration may be configured under the serving cell (e.g., included within the serving cell configuration 505), and the second RACH configuration may be configured under the candidate cell (e.g., included within the candidate cell configuration 510).

The first RACH configuration may include a PRACH configuration 515-a (e.g., a PRACH configuration 315) under the serving cell configuration 505, a RACH parameter configuration 520-a (e.g., a RACH parameter configuration 320) under the PRACH configuration 515-a, and a RAR window configuration 525-a (e.g., a RAR window configuration 525) under the RACH parameter configuration 520-a. The second RACH configuration may include a PRACH configuration 515-b (e.g., a PRACH configuration 315) under the candidate cell configuration 510, a RACH parameter configuration 520-b (e.g., a RACH parameter configuration 320) under the PRACH configuration 515-b, and a RAR window configuration 525-b (e.g., a RAR window configuration 525) under the RACH parameter configuration 520-b.

At least the RAR window configurations 525 may be different between the first RACH configuration and the second RACH configuration. For example, the first RACH configuration may include a RAR window configuration 525 that indicates an exclusion of a RAR window in response to the transmission of a RACH preamble for the purposes of obtaining timing advance information associated with the candidate cell. In some examples, the first RACH configuration may indicate the exclusion of the RAR window by excluding the RAR window configuration 525-a. The second RACH configuration may include a RAR window configuration 525-b including a configuration for a RAR window in response to the transmission of a RACH preamble (e.g., as part of initial access or other RACH process).

In some examples, the first and second RACH configurations (E.g., the PRACH configurations 515) may include an identifier associated with the candidate cell, so as to support the identification of the candidate cell RACH configurations separate from the serving cell RACH configuration (e.g., and one or more other candidate cell RACH configurations for other candidate cells included within or separate from the serving cell configuration 505).

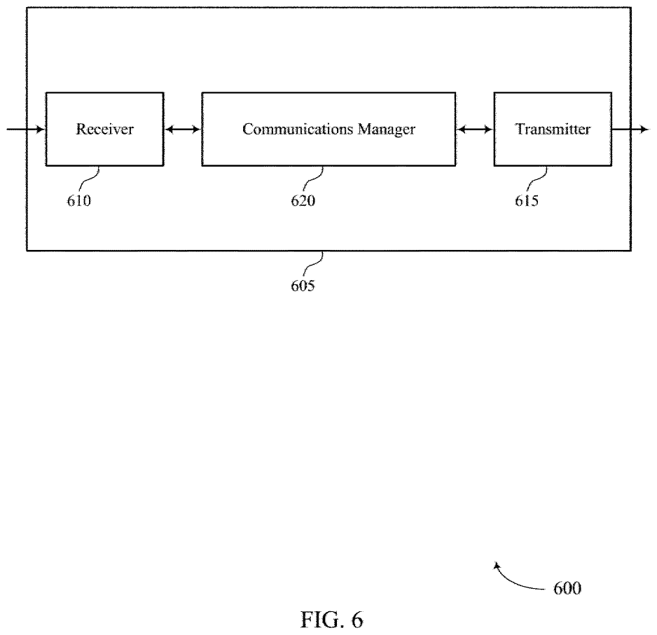

FIG. 6 illustrates a block diagram 600 of a device 605 that supports RACH configurations for candidate cell switching in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to RACH configurations for candidate cell switching). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to RACH configurations for candidate cell switching). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of RACH configurations for candidate cell switching as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. For example, the communications manager 620 may be configured as or otherwise support a means for receiving, via a serving cell associated with the UE, a first control message indicating a first RACH configuration and a second RACH configuration that are associated with a candidate cell, the first RACH configuration for the UE to use to communicate via the candidate cell before a switch to the candidate cell, the second RACH configuration for the UE to use to communicate via the candidate cell after the switch to the candidate cell. The communications manager 620 may be configured as or otherwise support a means for receiving a second control message indicating that the UE is to perform a RACH procedure to obtain timing advance information associated with the candidate cell. The communications manager 620 may be configured as or otherwise support a means for transmitting, before the switch to the candidate cell and based on the second control message, a first RACH message via the candidate cell in accordance with the first RACH configuration. The communications manager 620 may be configured as or otherwise support a means for transmitting, after performing the switch to the candidate cell and based on the timing advance information, a second RACH message via the candidate cell in accordance with the second RACH configuration.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for reduced processing and more efficient utilization of communication resources, for example, by supporting simplified RACH configurations for L1/L2 mobility.

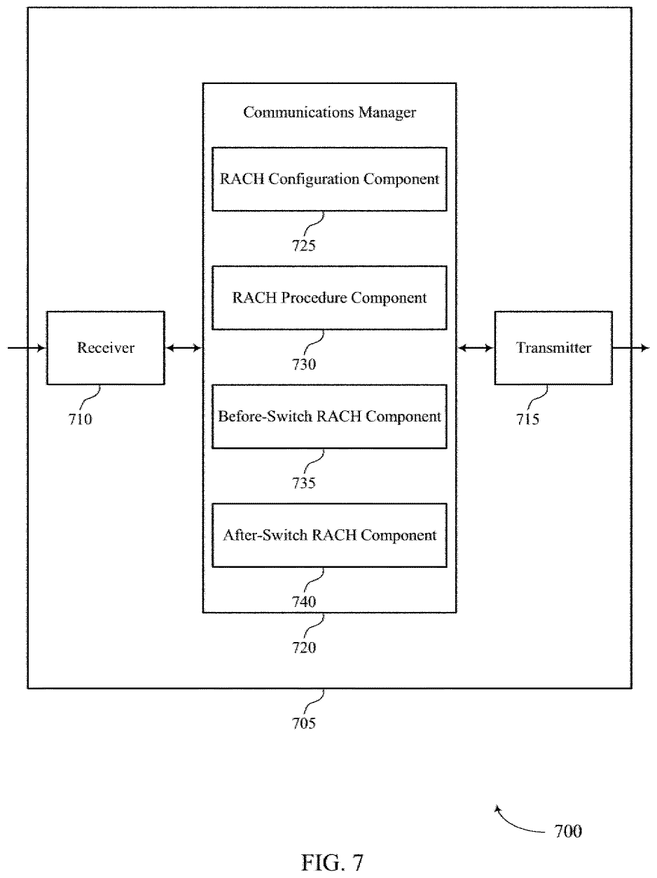

FIG. 7 illustrates a block diagram 700 of a device 705 that supports RACH configurations for candidate cell switching in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to RACH configurations for candidate cell switching). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to RACH configurations for candidate cell switching). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of RACH configurations for candidate cell switching as described herein. For example, the communications manager 720 may include a RACH configuration component 725, a RACH procedure component 730, a before-switch RACH component 735, an after-switch RACH component 740, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. The RACH configuration component 725 may be configured as or otherwise support a means for receiving, via a serving cell associated with the UE, a first control message indicating a first RACH configuration and a second RACH configuration that are associated with a candidate cell, the first RACH configuration for the UE to use to communicate via the candidate cell before a switch to the candidate cell, the second RACH configuration for the UE to use to communicate via the candidate cell after the switch to the candidate cell. The RACH procedure component 730 may be configured as or otherwise support a means for receiving a second control message indicating that the UE is to perform a RACH procedure to obtain timing advance information associated with the candidate cell. The before-switch RACH component 735 may be configured as or otherwise support a means for transmit, before the switch to the candidate cell and based on the second control message, a first RACH message via the candidate cell in accordance with the first RACH configuration. The after-switch RACH component 740 may be configured as or otherwise support a means for transmit, after performing the switch to the candidate cell and based on the timing advance information, a second RACH message via the candidate cell in accordance with the second RACH configuration.

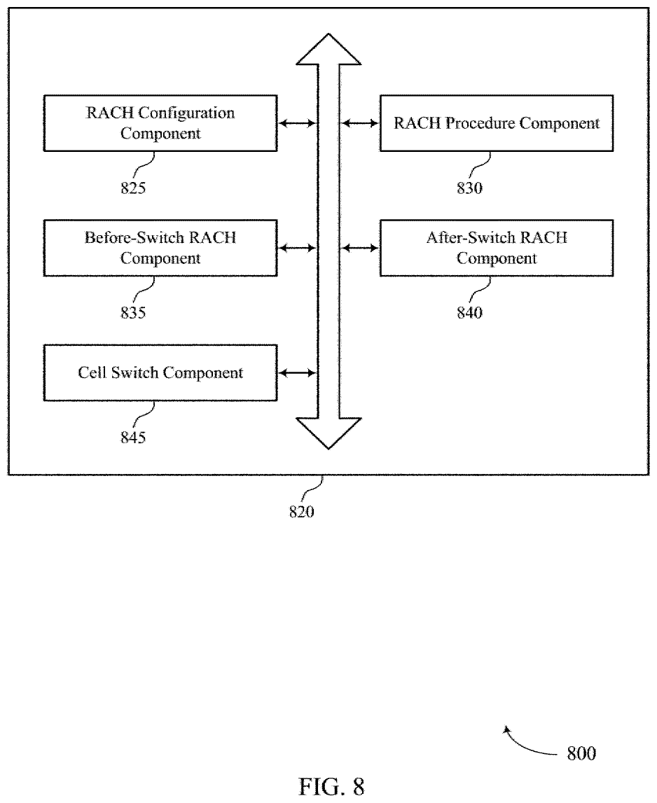

FIG. 8 illustrates a block diagram 800 of a communications manager 820 that supports RACH configurations for candidate cell switching in accordance with one or more aspects of the present disclosure. The communications manager 820 may be an example of aspects of a communications manager 620, a communications manager 720, or both, as described herein. The communications manager 820, or various components thereof, may be an example of means for performing various aspects of RACH configurations for candidate cell switching as described herein. For example, the communications manager 820 may include a RACH configuration component 825, a RACH procedure component 830, a before-switch RACH component 835, an after-switch RACH component 840, a cell switch component 845, or any combination thereof. Each of these components may communicate, directly or indirectly, with one another (e.g., via one or more buses).

The communications manager 820 may support wireless communication at a UE in accordance with examples as disclosed herein. The RACH configuration component 825 may be configured as or otherwise support a means for receiving, via a serving cell associated with the UE, a first control message indicating a first RACH configuration and a second RACH configuration that are associated with a candidate cell, the first RACH configuration for the UE to use to communicate via the candidate cell before a switch to the candidate cell, the second RACH configuration for the UE to use to communicate via the candidate cell after the switch to the candidate cell. The RACH procedure component 830 may be configured as or otherwise support a means for receiving a second control message indicating that the UE is to perform a RACH procedure to obtain timing advance information associated with the candidate cell. The before-switch RACH component 835 may be configured as or otherwise support a means for transmit, before the switch to the candidate cell and based on the second control message, a first RACH message via the candidate cell in accordance with the first RACH configuration. The after-switch RACH component 840 may be configured as or otherwise support a means for transmit, after performing the switch to the candidate cell and based on the timing advance information, a second RACH message via the candidate cell in accordance with the second RACH configuration.

In some examples, the cell switch component 845 may be configured as or otherwise support a means for receiving, via the serving cell or the candidate cell, a third control message indicating that the UE is to perform the switch to the candidate cell, the third control message indicating the timing advance information associated with the candidate cell.

In some examples, the cell switch component 845 may be configured as or otherwise support a means for performing the switch to the candidate cell after transmitting the first RACH message and before transmitting the second RACH message, where the second RACH message is communicated in accordance with the second RACH configuration based on performing the switch.

In some examples, the first RACH configuration and the second RACH configuration are included within a RACH configuration associated with the serving cell.

In some examples, the first RACH configuration includes a first PRACH configuration associated with the candidate cell, a first RACH parameter configuration associated with the candidate cell, and a first RAR window configuration associated with the candidate cell, the first RAR window configuration indicating an exclusion of a RAR window associated with the first RACH message. In some examples, the second RACH configuration includes a second PRACH configuration associated with the candidate cell, a second RACH parameter configuration associated with the candidate cell, and a second RAR window configuration associated with the candidate cell.

In some examples, the first RACH configuration and the second RACH configuration are included within a same PRACH configuration associated with the candidate cell. In some examples, the first RACH configuration includes a first RACH parameter configuration associated with the candidate cell and a first RAR window configuration associated with the candidate cell, the first RAR window configuration indicating an exclusion of a RAR window associated with the first RACH message. In some examples, the second RACH configuration includes a second RACH parameter configuration associated with the candidate cell and a second RAR window configuration associated with the candidate cell.

In some examples, the first RACH configuration and the second RACH configuration are included within a same PRACH configuration associated with the candidate cell and a same RACH parameter configuration associated with the candidate cell. In some examples, the first RACH configuration includes a first RAR window configuration associated with the candidate cell, the first RAR window configuration indicating an exclusion of a RAR window associated with the first RACH message. In some examples, the second RACH configuration includes a second RAR window configuration associated with the candidate cell.

In some examples, the first RACH configuration and the second RACH configuration are included within a RACH configuration associated with the candidate cell. In some examples, the first RACH configuration includes a first RAR window configuration associated with the candidate cell, the first RAR window configuration indicating an exclusion of a RAR window associated with the first RACH message. In some examples, the second RACH configuration includes a second RAR window configuration associated with the candidate cell.

In some examples, the first RACH configuration is included within a RACH configuration associated with the serving cell and includes a first RAR window configuration associated with the candidate cell, the first RAR window configuration indicating an exclusion of a RAR window associated with the first RACH message. In some examples, the second RACH configuration is included within a RACH configuration associated with the candidate cell and includes a second RAR window configuration associated with the candidate cell.

In some examples, to support receiving the second control message, the RACH procedure component 830 may be configured as or otherwise support a means for receiving the second control message via the serving cell or via the candidate cell.

In some examples, the first RACH configuration and the second RACH configuration include an identifier associated with the candidate cell.

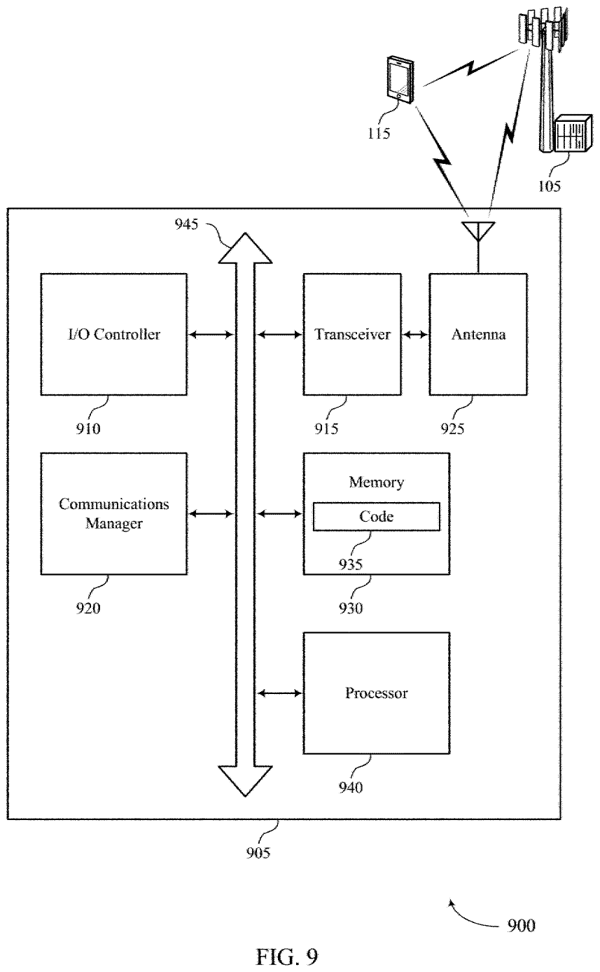

FIG. 9 illustrates a diagram of a system 900 including a device 905 that supports RACH configurations for candidate cell switching in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting RACH configurations for candidate cell switching). For example, the device 905 or a component of the device 905 may include a processor 940 and memory 930 coupled with or to the processor 940, the processor 940 and memory 930 configured to perform various functions described herein.

The communications manager 920 may support wireless communication at a UE in accordance with examples as disclosed herein. For example, the communications manager 920 may be configured as or otherwise support a means for receiving, via a serving cell associated with the UE, a first control message indicating a first RACH configuration and a second RACH configuration that are associated with a candidate cell, the first RACH configuration for the UE to use to communicate via the candidate cell before a switch to the candidate cell, the second RACH configuration for the UE to use to communicate via the candidate cell after the switch to the candidate cell. The communications manager 920 may be configured as or otherwise support a means for receiving a second control message indicating that the UE is to perform a RACH procedure to obtain timing advance information associated with the candidate cell. The communications manager 920 may be configured as or otherwise support a means for transmitting, before the switch to the candidate cell and based on the second control message, a first RACH message via the candidate cell in accordance with the first RACH configuration. The communications manager 920 may be configured as or otherwise support a means for transmitting, after performing the switch to the candidate cell and based on the timing advance information, a second RACH message via the candidate cell in accordance with the second RACH configuration.

By including or configuring the communications manager 920 in accordance with examples as described herein, the device 905 may support techniques for cell mobility via L1 and/or L2 signaling, reduced latency, increased resource usage efficiency, increased RACH configuration flexibility, and improved coordination between devices, among other benefits.

In some examples, the communications manager 920 may be configured to perform various operations (e.g., receiving, monitoring, transmitting) using or otherwise in cooperation with the transceiver 915, the one or more antennas 925, or any combination thereof. For example, the communications manager 920 may be configured to receive or transmit messages or other signaling as described herein via the transceiver 915. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of RACH configurations for candidate cell switching as described herein, or the processor 940 and the memory 930 may be otherwise configured to perform or support such operations.

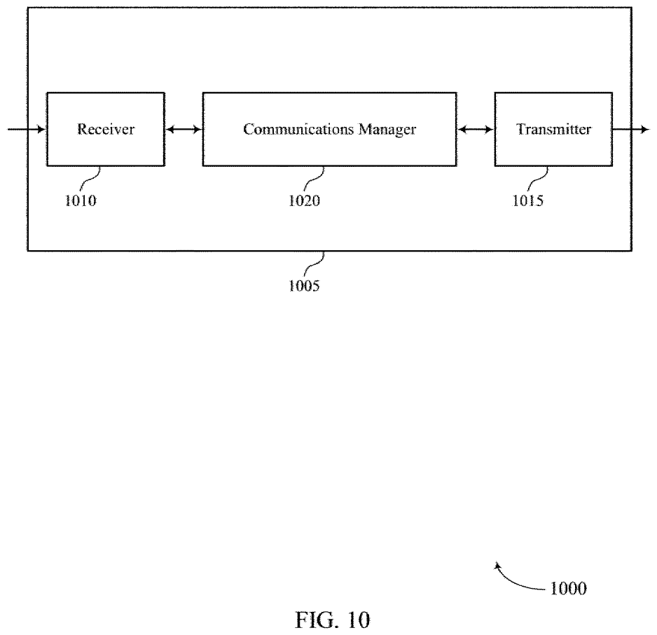

FIG. 10 illustrates a block diagram 1000 of a device 1005 that supports RACH configurations for candidate cell switching in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of RACH configurations for candidate cell switching as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network entity in accordance with examples as disclosed herein. For example, the communications manager 1020 may be configured as or otherwise support a means for transmitting, via a serving cell associated with a UE, a first control message indicating a first RACH configuration and a second RACH configuration that are associated with a candidate cell, the first RACH configuration for the UE to use to communicate via the candidate cell before a switch to the candidate cell, the second RACH configuration for the UE to use to communicate via the candidate cell after the switch to the candidate cell. The communications manager 1020 may be configured as or otherwise support a means for transmitting, via the serving cell, a second control message indicating that the UE is to perform, based on the first RACH configuration, a RACH procedure to obtain timing advance information associated with the candidate cell.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for reduced processing and more efficient utilization of communication resources, for example, by supporting simplified RACH configurations for L1/L2 mobility

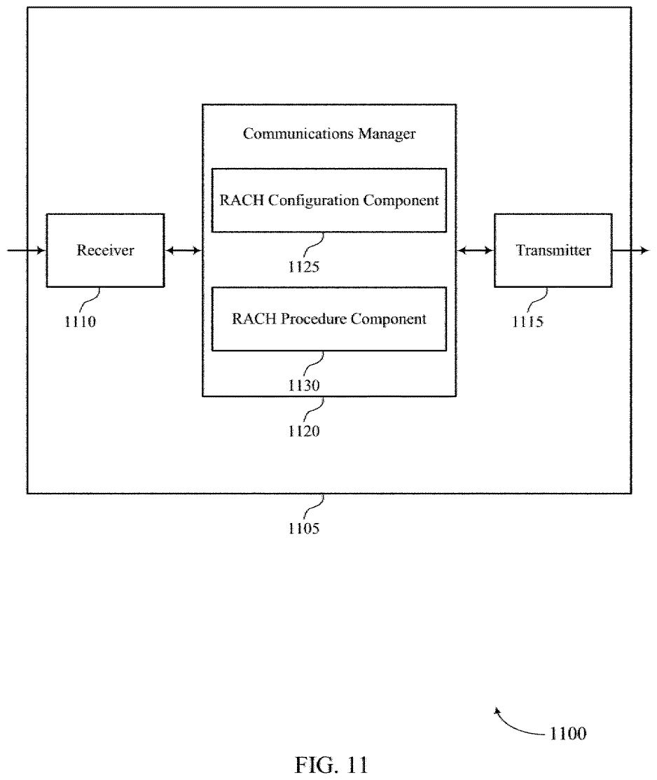

FIG. 11 illustrates a block diagram 1100 of a device 1105 that supports RACH configurations for candidate cell switching in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of RACH configurations for candidate cell switching as described herein. For example, the communications manager 1120 may include a RACH configuration component 1125 a RACH procedure component 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network entity in accordance with examples as disclosed herein. The RACH configuration component 1125 may be configured as or otherwise support a means for transmitting, via a serving cell associated with a UE, a first control message indicating a first RACH configuration and a second RACH configuration that are associated with a candidate cell, the first RACH configuration for the UE to use to communicate via the candidate cell before a switch to the candidate cell, the second RACH configuration for the UE to use to communicate via the candidate cell after the switch to the candidate cell. The RACH procedure component 1130 may be configured as or otherwise support a means for transmitting, via the serving cell, a second control message indicating that the UE is to perform, based on the first RACH configuration, a RACH procedure to obtain timing advance information associated with the candidate cell.

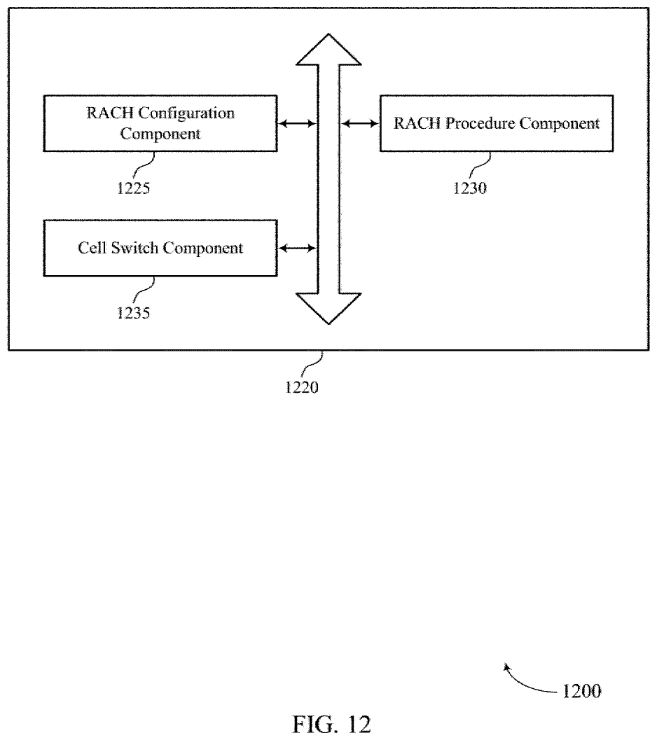

FIG. 12 illustrates a block diagram 1200 of a communications manager 1220 that supports RACH configurations for candidate cell switching in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of RACH configurations for candidate cell switching as described herein. For example, the communications manager 1220 may include a RACH configuration component 1225, a RACH procedure component 1230, a cell switch component 1235, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communication at a network entity in accordance with examples as disclosed herein. The RACH configuration component 1225 may be configured as or otherwise support a means for transmitting, via a serving cell associated with a UE, a first control message indicating a first RACH configuration and a second RACH configuration that are associated with a candidate cell, the first RACH configuration for the UE to use to communicate via the candidate cell before a switch to the candidate cell, the second RACH configuration for the UE to use to communicate via the candidate cell after the switch to the candidate cell. The RACH procedure component 1230 may be configured as or otherwise support a means for transmitting, via the serving cell, a second control message indicating that the UE is to perform, based on the first RACH configuration, a RACH procedure to obtain timing advance information associated with the candidate cell.

In some examples, the cell switch component 1235 may be configured as or otherwise support a means for transmitting, via the serving cell, a third control message indicating that the UE is to perform, based on the second RACH configuration, the switch to the candidate cell, the third control message indicating the timing advance information associated with the candidate cell.

In some examples, the first RACH configuration and the second RACH configuration are included within a RACH configuration associated with the serving cell.

In some examples, the first RACH configuration includes a first PRACH configuration associated with the candidate cell, a first RACH parameter configuration associated with the candidate cell, and a first RAR window configuration associated with the candidate cell, the first RAR window configuration indicating an exclusion of a RAR window associated with the first RACH configuration. In some examples, the second RACH configuration includes a second PRACH configuration associated with the candidate cell, a second RACH parameter configuration associated with the candidate cell, and a second RAR window configuration associated with the candidate cell.

In some examples, the first RACH configuration and the second RACH configuration are included within a same PRACH configuration associated with the candidate cell. In some examples, the first RACH configuration includes a first RACH parameter configuration associated with the candidate cell and a first RAR window configuration associated with the candidate cell, the first RAR window configuration indicating an exclusion of a RAR window associated with the first RACH configuration. In some examples, the second RACH configuration includes a second RACH parameter configuration associated with the candidate cell and a second RAR window configuration associated with the candidate cell.

In some examples, the first RACH configuration and the second RACH configuration are included within a same PRACH configuration associated with the candidate cell and a same RACH parameter configuration associated with the candidate cell. In some examples, the first RACH configuration includes a first RAR window configuration associated with the candidate cell, the first RAR window configuration indicating an exclusion of a RAR window associated with the first RACH configuration. In some examples, the second RACH configuration includes a second RAR window configuration associated with the candidate cell.

In some examples, the first RACH configuration and the second RACH configuration are included within a RACH configuration associated with the candidate cell. In some examples, the first RACH configuration includes a first RAR window configuration associated with the candidate cell, the first RAR window configuration indicating an exclusion of a RAR window associated with the first RACH configuration. In some examples, the second RACH configuration includes a second RAR window configuration associated with the candidate cell.

In some examples, the first RACH configuration is included within a RACH configuration associated with the serving cell and includes a first RAR window configuration associated with the candidate cell, the first RAR window configuration indicating an exclusion of a RAR window associated with the first RACH configuration. In some examples, the second RACH configuration is included within a RACH configuration associated with the candidate cell and includes a second RAR window configuration associated with the candidate cell.

In some examples, the first RACH configuration and the second RACH configuration include an identifier associated with the candidate cell.

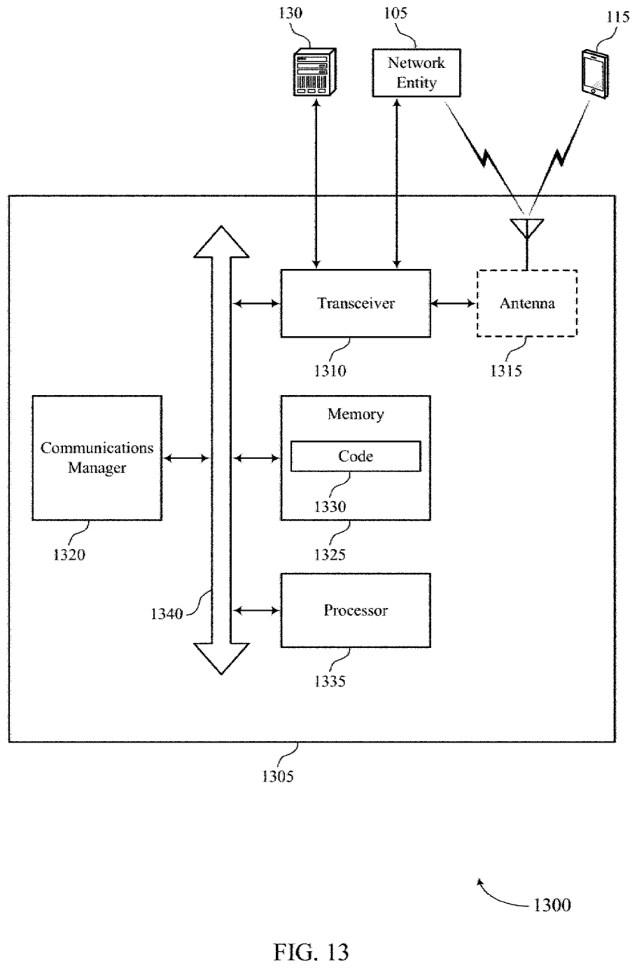

FIG. 13 illustrates a diagram of a system 1300 including a device 1305 that supports RACH configurations for candidate cell switching in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or memory components (for example, the processor 1335, or the memory 1325, or both), may be included in a chip or chip assembly that is installed in the device 1305. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting RACH configurations for candidate cell switching). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305. The processor 1335 may be any one or more suitable processors capable of executing scripts or instructions of one or more software programs stored in the device 1305 (such as within the memory 1325). In some implementations, the processor 1335 may be a component of a processing system. A processing system may generally refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the processor 1335, or the transceiver 1310, or the communications manager 1320, or other components or combinations of components of the device 1305. The processing system of the device 1305 may interface with other components of the device 1305, and may process information received from other components (such as inputs or signals) or output information to other components. For example, a chip or modem of the device 1305 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1305 may transmit information output from the chip or modem. Additionally, or alternatively, in some implementations, the one or more interfaces may refer to an interface between the processing system of the chip or modem and a receiver, such that the device 1305 may obtain information or signal inputs, and the information may be passed to the processing system. A person having ordinary skill in the art will readily recognize that a first interface also may obtain information or signal inputs, and a second interface also may output information or signal outputs.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communication at a network entity in accordance with examples as disclosed herein. For example, the communications manager 1320 may be configured as or otherwise support a means for transmitting, via a serving cell associated with a UE, a first control message indicating a first RACH configuration and a second RACH configuration that are associated with a candidate cell, the first RACH configuration for the UE to use to communicate via the candidate cell before a switch to the candidate cell, the second RACH configuration for the UE to use to communicate via the candidate cell after the switch to the candidate cell. The communications manager 1320 may be configured as or otherwise support a means for transmitting, via the serving cell, a second control message indicating that the UE is to perform, based on the first RACH configuration, a RACH procedure to obtain timing advance information associated with the candidate cell.

By including or configuring the communications manager 1320 in accordance with examples as described herein, the device 1305 may support techniques for cell mobility via L1 and/or L2 signaling, reduced latency, increased resource usage efficiency, increased RACH configuration flexibility, and improved coordination between devices, among other benefits.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. For example, the communications manager 1320 may be configured to receive or transmit messages or other signaling as described herein via the transceiver 1310. Although the communications manager 1320 is illustrated as a separate component, in some examples, one or more functions described with reference to the communications manager 1320 may be supported by or performed by the transceiver 1310, the processor 1335, the memory 1325, the code 1330, or any combination thereof. For example, the code 1330 may include instructions executable by the processor 1335 to cause the device 1305 to perform various aspects of RACH configurations for candidate cell switching as described herein, or the processor 1335 and the memory 1325 may be otherwise configured to perform or support such operations.

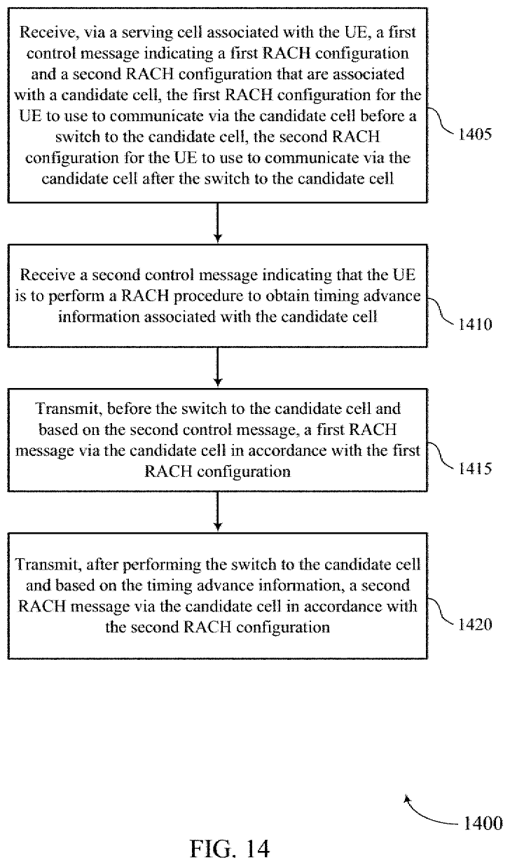

FIG. 14 illustrates a flowchart showing a method 1400 that supports RACH configurations for candidate cell switching in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving, via a serving cell associated with the UE, a first control message indicating a first RACH configuration and a second RACH configuration that are associated with a candidate cell, the first RACH configuration for the UE to use to communicate via the candidate cell before a switch to the candidate cell, the second RACH configuration for the UE to use to communicate via the candidate cell after the switch to the candidate cell. The operations of 1405 may be performed in accordance with examples as disclosed herein. In some examples, aspects of the operations of 1405 may be performed by a RACH configuration component 825 as described with reference to FIG. 8. Additionally or alternatively, means for performing 1405 may, but not necessarily, include, for example, antenna 925, transceiver 915, communications manager 920, memory 930 (including code 935), processor 940 and/or bus 945.

At 1410, the method may include receiving a second control message indicating that the UE is to perform a RACH procedure to obtain timing advance information associated with the candidate cell. The operations of 1410 may be performed in accordance with examples as disclosed herein. In some examples, aspects of the operations of 1410 may be performed by a RACH procedure component 830 as described with reference to FIG. 8. Additionally or alternatively, means for performing 1405 may, but not necessarily, include, for example, antenna 925, transceiver 915, communications manager 920, memory 930 (including code 935), processor 940 and/or bus 945.

At 1415, the method may include transmitting, before the switch to the candidate cell and based on the second control message, a first RACH message via the candidate cell in accordance with the first RACH configuration. The operations of 1415 may be performed in accordance with examples as disclosed herein. In some examples, aspects of the operations of 1415 may be performed by a before-switch RACH component 835 as described with reference to FIG. 8. Additionally or alternatively, means for performing 1405 may, but not necessarily, include, for example, antenna 925, transceiver 915, communications manager 920, memory 930 (including code 935), processor 940 and/or bus 945.

At 1420, the method may include transmitting, after performing the switch to the candidate cell and based on the timing advance information, a second RACH message via the candidate cell in accordance with the second RACH configuration. The operations of 1420 may be performed in accordance with examples as disclosed herein. In some examples, aspects of the operations of 1420 may be performed by an after-switch RACH component 840 as described with reference to FIG. 8. Additionally or alternatively, means for performing 1405 may, but not necessarily, include, for example, antenna 925, transceiver 915, communications manager 920, memory 930 (including code 935), processor 940 and/or bus 945.

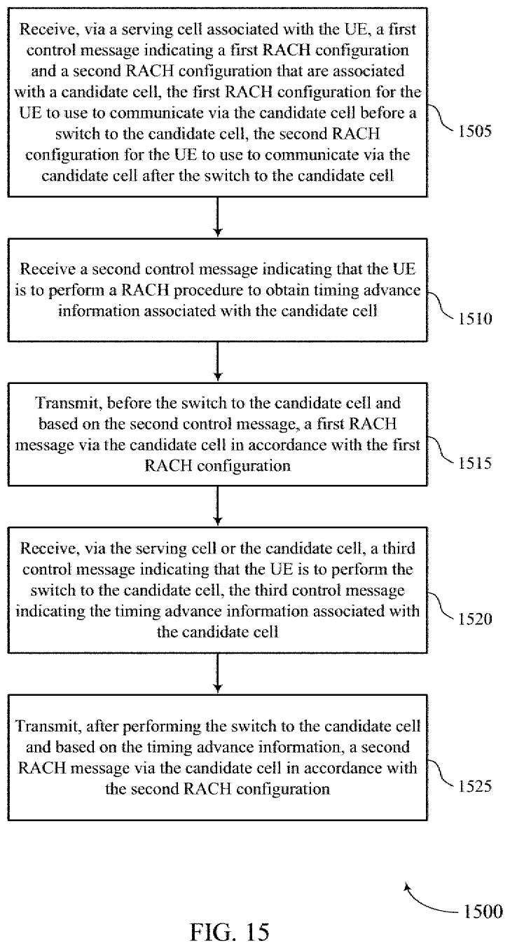

FIG. 15 illustrates a flowchart showing a method 1500 that supports RACH configurations for candidate cell switching in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving, via a serving cell associated with the UE, a first control message indicating a first RACH configuration and a second RACH configuration that are associated with a candidate cell, the first RACH configuration for the UE to use to communicate via the candidate cell before a switch to the candidate cell, the second RACH configuration for the UE to use to communicate via the candidate cell after the switch to the candidate cell. The operations of 1505 may be performed in accordance with examples as disclosed herein. In some examples, aspects of the operations of 1505 may be performed by a RACH configuration component 825 as described with reference to FIG. 8. Additionally or alternatively, means for performing 1405 may, but not necessarily, include, for example, antenna 925, transceiver 915, communications manager 920, memory 930 (including code 935), processor 940 and/or bus 945.

At 1510, the method may include receiving a second control message indicating that the UE is to perform a RACH procedure to obtain timing advance information associated with the candidate cell. The operations of 1510 may be performed in accordance with examples as disclosed herein. In some examples, aspects of the operations of 1510 may be performed by a RACH procedure component 830 as described with reference to FIG. 8. Additionally or alternatively, means for performing 1405 may, but not necessarily, include, for example, antenna 925, transceiver 915, communications manager 920, memory 930 (including code 935), processor 940 and/or bus 945.

At 1515, the method may include transmit, before the switch to the candidate cell and based on the second control message, a first RACH message via the candidate cell in accordance with the first RACH configuration. The operations of 1515 may be performed in accordance with examples as disclosed herein. In some examples, aspects of the operations of 1515 may be performed by a before-switch RACH component 835 as described with reference to FIG. 8. Additionally or alternatively, means for performing 1405 may, but not necessarily, include, for example, antenna 925, transceiver 915, communications manager 920, memory 930 (including code 935), processor 940 and/or bus 945.

At 1520, the method may include receiving, via the serving cell or the candidate cell, a third control message indicating that the UE is to perform the switch to the candidate cell, the third control message indicating the timing advance information associated with the candidate cell. The operations of 1520 may be performed in accordance with examples as disclosed herein. In some examples, aspects of the operations of 1520 may be performed by a cell switch component 845 as described with reference to FIG. 8. Additionally or alternatively, means for performing 1405 may, but not necessarily, include, for example, antenna 925, transceiver 915, communications manager 920, memory 930 (including code 935), processor 940 and/or bus 945.

At 1525, the method may include transmit, after performing the switch to the candidate cell and based on the timing advance information, a second RACH message via the candidate cell in accordance with the second RACH configuration. The operations of 1525 may be performed in accordance with examples as disclosed herein. In some examples, aspects of the operations of 1525 may be performed by an after-switch RACH component 840 as described with reference to FIG. 8. Additionally or alternatively, means for performing 1405 may, but not necessarily, include, for example, antenna 925, transceiver 915, communications manager 920, memory 930 (including code 935), processor 940 and/or bus 945.

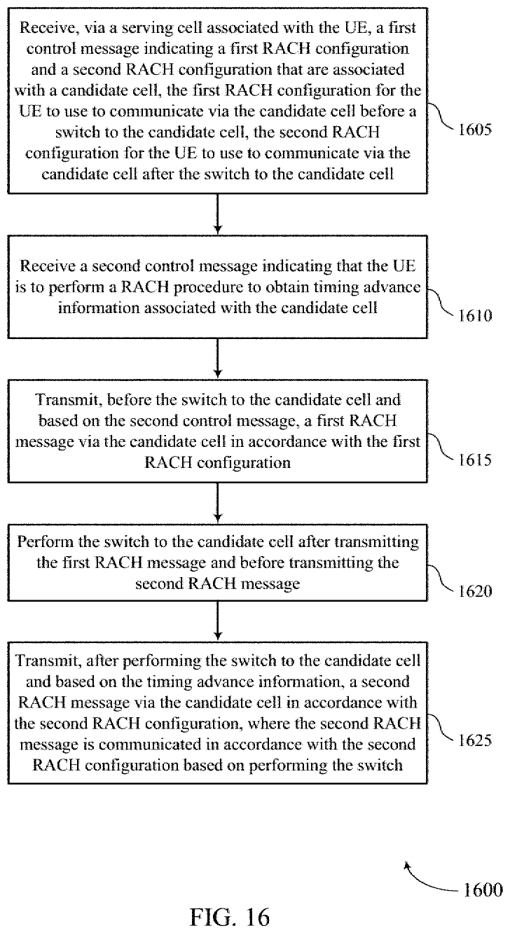

FIG. 16 illustrates a flowchart showing a method 1600 that supports RACH configurations for candidate cell switching in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include receiving, via a serving cell associated with the UE, a first control message indicating a first RACH configuration and a second RACH configuration that are associated with a candidate cell, the first RACH configuration for the UE to use to communicate via the candidate cell before a switch to the candidate cell, the second RACH configuration for the UE to use to communicate via the candidate cell after the switch to the candidate cell. The operations of 1605 may be performed in accordance with examples as disclosed herein. In some examples, aspects of the operations of 1605 may be performed by a RACH configuration component 825 as described with reference to FIG. 8. Additionally or alternatively, means for performing 1405 may, but not necessarily, include, for example, antenna 925, transceiver 915, communications manager 920, memory 930 (including code 935), processor 940 and/or bus 945.

At 1610, the method may include receiving a second control message indicating that the UE is to perform a RACH procedure to obtain timing advance information associated with the candidate cell. The operations of 1610 may be performed in accordance with examples as disclosed herein. In some examples, aspects of the operations of 1610 may be performed by a RACH procedure component 830 as described with reference to FIG. 8. Additionally or alternatively, means for performing 1405 may, but not necessarily, include, for example, antenna 925, transceiver 915, communications manager 920, memory 930 (including code 935), processor 940 and/or bus 945.

At 1615, the method may include transmit, before the switch to the candidate cell and based on the second control message, a first RACH message via the candidate cell in accordance with the first RACH configuration. The operations of 1615 may be performed in accordance with examples as disclosed herein. In some examples, aspects of the operations of 1615 may be performed by a before-switch RACH component 835 as described with reference to FIG. 8. Additionally or alternatively, means for performing 1405 may, but not necessarily, include, for example, antenna 925, transceiver 915, communications manager 920, memory 930 (including code 935), processor 940 and/or bus 945.

At 1620, the method may include performing the switch to the candidate cell after transmitting the first RACH message and before transmitting the second RACH message. The operations of 1620 may be performed in accordance with examples as disclosed herein. In some examples, aspects of the operations of 1620 may be performed by a cell switch component 845 as described with reference to FIG. 8. Additionally or alternatively, means for performing 1405 may, but not necessarily, include, for example, antenna 925, transceiver 915, communications manager 920, memory 930 (including code 935), processor 940 and/or bus 945.

At 1625, the method may include transmit, after performing the switch to the candidate cell and based on the timing advance information, a second RACH message via the candidate cell in accordance with the second RACH configuration, where the second RACH message is communicated in accordance with the second RACH configuration based on performing the switch. The operations of 1625 may be performed in accordance with examples as disclosed herein. In some examples, aspects of the operations of 1625 may be performed by an after-switch RACH component 840 as described with reference to FIG. 8. Additionally or alternatively, means for performing 1405 may, but not necessarily, include, for example, antenna 925, transceiver 915, communications manager 920, memory 930 (including code 935), processor 940 and/or bus 945.

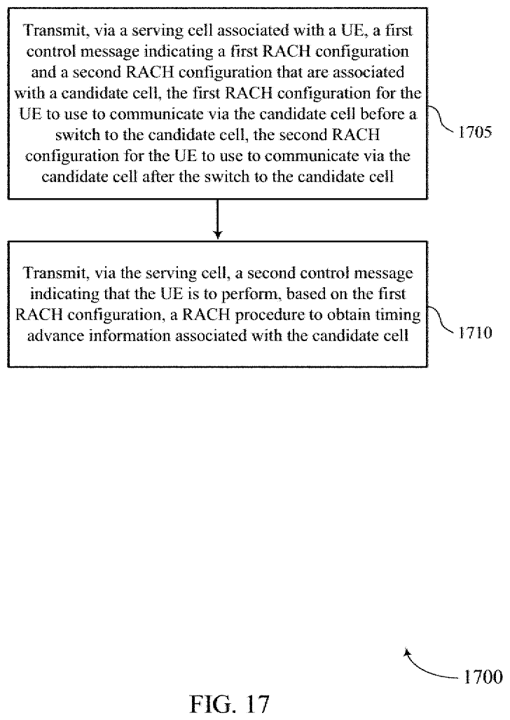

FIG. 17 illustrates a flowchart showing a method 1700 that supports RACH configurations for candidate cell switching in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include transmitting, via a serving cell associated with a UE, a first control message indicating a first RACH configuration and a second RACH configuration that are associated with a candidate cell, the first RACH configuration for the UE to use to communicate via the candidate cell before a switch to the candidate cell, the second RACH configuration for the UE to use to communicate via the candidate cell after the switch to the candidate cell. The operations of 1705 may be performed in accordance with examples as disclosed herein. In some examples, aspects of the operations of 1705 may be performed by a RACH configuration component 1225 as described with reference to FIG. 12. Additionally or alternatively, means for performing 1405 may, but not necessarily, include, for example, antenna 1315, transceiver 1310, communications manager 1320, memory 1325 (including code 1330), processor 1335 and/or bus 1340.

At 1710, the method may include transmitting, via the serving cell, a second control message indicating that the UE is to perform, based on the first RACH configuration, a RACH procedure to obtain timing advance information associated with the candidate cell. The operations of 1710 may be performed in accordance with examples as disclosed herein. In some examples, aspects of the operations of 1710 may be performed by a RACH procedure component 1230 as described with reference to FIG. 12. Additionally or alternatively, means for performing 1405 may, but not necessarily, include, for example, antenna 1315, transceiver 1310, communications manager 1320, memory 1325 (including code 1330), processor 1335 and/or bus 1340.

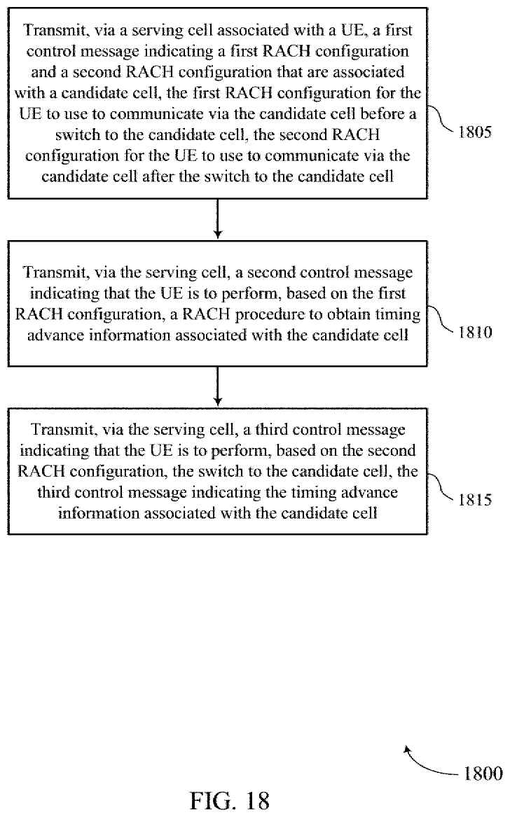

FIG. 18 illustrates a flowchart showing a method 1800 that supports RACH configurations for candidate cell switching in accordance with one or more aspects of the present disclosure. The operations of the method 1800 may be implemented by a network entity or its components as described herein. For example, the operations of the method 1800 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1805, the method may include transmitting, via a serving cell associated with a UE, a first control message indicating a first RACH configuration and a second RACH configuration that are associated with a candidate cell, the first RACH configuration for the UE to use to communicate via the candidate cell before a switch to the candidate cell, the second RACH configuration for the UE to use to communicate via the candidate cell after the switch to the candidate cell. The operations of 1805 may be performed in accordance with examples as disclosed herein. In some examples, aspects of the operations of 1805 may be performed by a RACH configuration component 1225 as described with reference to FIG. 12. Additionally or alternatively, means for performing 1405 may, but not necessarily, include, for example, antenna 1315, transceiver 1310, communications manager 1320, memory 1325 (including code 1330), processor 1335 and/or bus 1340.

At 1810, the method may include transmitting, via the serving cell, a second control message indicating that the UE is to perform, based on the first RACH configuration, a RACH procedure to obtain timing advance information associated with the candidate cell. The operations of 1810 may be performed in accordance with examples as disclosed herein. In some examples, aspects of the operations of 1810 may be performed by a RACH procedure component 1230 as described with reference to FIG. 12. Additionally or alternatively, means for performing 1405 may, but not necessarily, include, for example, antenna 1315, transceiver 1310, communications manager 1320, memory 1325 (including code 1330), processor 1335 and/or bus 1340.

At 1815, the method may include transmitting, via the serving cell, a third control message indicating that the UE is to perform, based on the second RACH configuration, the switch to the candidate cell, the third control message indicating the timing advance information associated with the candidate cell. The operations of 1815 may be performed in accordance with examples as disclosed herein. In some examples, aspects of the operations of 1815 may be performed by a cell switch component 1235 as described with reference to FIG. 12. Additionally or alternatively, means for performing 1405 may, but not necessarily, include, for example, antenna 1315, transceiver 1310, communications manager 1320, memory 1325 (including code 1330), processor 1335 and/or bus 1340.

The following provides an overview of aspects of the present disclosure:

Aspect 1: A method for wireless communication at a UE, comprising: receiving, via a serving cell associated with the UE, a first control message indicating a first RACH configuration and a second RACH configuration that are associated with a candidate cell, the first RACH configuration for the UE to use to communicate via the candidate cell before a switch to the candidate cell, the second RACH configuration for the UE to use to communicate via the candidate cell after the switch to the candidate cell; receiving a second control message indicating that the UE is to perform a RACH procedure to obtain timing advance information associated with the candidate cell; transmit, before the switch to the candidate cell and based at least in part on the second control message, a first RACH message via the candidate cell in accordance with the first RACH configuration; and transmit, after performing the switch to the candidate cell and based at least in part on the timing advance information, a second RACH message via the candidate cell in accordance with the second RACH configuration.

Aspect 2: The method of aspect 1, further comprising: receiving, via the serving cell or the candidate cell, a third control message indicating that the UE is to perform the switch to the candidate cell, the third control message indicating the timing advance information associated with the candidate cell.

Aspect 3: The method of any of aspects 1 through 2, further comprising: performing the switch to the candidate cell after transmitting the first RACH message and before transmitting the second RACH message, wherein the second RACH message is communicated in accordance with the second RACH configuration based at least in part on performing the switch.

Aspect 4: The method of any of aspects 1 through 3, wherein the first RACH configuration and the second RACH configuration are included within a RACH configuration associated with the serving cell.

Aspect 5: The method of aspect 4, wherein the first RACH configuration comprises a first PRACH configuration associated with the candidate cell, a first RACH parameter configuration associated with the candidate cell, and a first RAR window configuration associated with the candidate cell, the first RAR window configuration indicating an exclusion of a RAR window associated with the first RACH message, and the second RACH configuration comprises a second PRACH configuration associated with the candidate cell, a second RACH parameter configuration associated with the candidate cell, and a second RAR window configuration associated with the candidate cell.

Aspect 6: The method of aspect 4, wherein the first RACH configuration and the second RACH configuration are included within a same PRACH configuration associated with the candidate cell, the first RACH configuration comprises a first RACH parameter configuration associated with the candidate cell and a first RAR window configuration associated with the candidate cell, the first RAR window configuration indicating an exclusion of a RAR window associated with the first RACH message, and the second RACH configuration comprises a second RACH parameter configuration associated with the candidate cell and a second RAR window configuration associated with the candidate cell.

Aspect 7: The method of aspect 4, wherein the first RACH configuration and the second RACH configuration are included within a same PRACH configuration associated with the candidate cell and a same RACH parameter configuration associated with the candidate cell, the first RACH configuration comprises a first RAR window configuration associated with the candidate cell, the first RAR window configuration indicating an exclusion of a RAR window associated with the first RACH message, and the second RACH configuration comprises a second RAR window configuration associated with the candidate cell.

Aspect 8: The method of any of aspects 1 through 3, wherein the first RACH configuration and the second RACH configuration are included within a RACH configuration associated with the candidate cell, the first RACH configuration comprises a first RAR window configuration associated with the candidate cell, the first RAR window configuration indicating an exclusion of a RAR window associated with the first RACH message, and the second RACH configuration comprises a second RAR window configuration associated with the candidate cell.

Aspect 9: The method of any of aspects 1 through 3, wherein the first RACH configuration is included within a RACH configuration associated with the serving cell and comprises a first RAR window configuration associated with the candidate cell, the first RAR window configuration indicating an exclusion of a RAR window associated with the first RACH message, and the second RACH configuration is included within a RACH configuration associated with the candidate cell and comprises a second RAR window configuration associated with the candidate cell.

Aspect 10: The method of any of aspects 1 through 9, wherein receiving the second control message comprises: receiving the second control message via the serving cell or via the candidate cell.

Aspect 11: The method of any of aspects 1 through 10, wherein the first RACH configuration and the second RACH configuration comprise an identifier associated with the candidate cell.

Aspect 12: A method for wireless communication at a network entity, comprising: transmitting, via a serving cell associated with a UE, a first control message indicating a first RACH configuration and a second RACH configuration that are associated with a candidate cell, the first RACH configuration for the UE to use to communicate via the candidate cell before a switch to the candidate cell, the second RACH configuration for the UE to use to communicate via the candidate cell after the switch to the candidate cell; and transmitting, via the serving cell, a second control message indicating that the UE is to perform, based at least in part on the first RACH configuration, a RACH procedure to obtain timing advance information associated with the candidate cell.

Aspect 13: The method of aspect 12, further comprising: transmitting, via the serving cell, a third control message indicating that the UE is to perform, based at least in part on the second RACH configuration, the switch to the candidate cell, the third control message indicating the timing advance information associated with the candidate cell.

Aspect 14: The method of any of aspects 12 through 13, wherein the first RACH configuration and the second RACH configuration are included within a RACH configuration associated with the serving cell.

Aspect 15: The method of aspect 14, wherein the first RACH configuration comprises a first PRACH configuration associated with the candidate cell, a first RACH parameter configuration associated with the candidate cell, and a first RAR window configuration associated with the candidate cell, the first RAR window configuration indicating an exclusion of a RAR window associated with the first RACH configuration, and the second RACH configuration comprises a second PRACH configuration associated with the candidate cell, a second RACH parameter configuration associated with the candidate cell, and a second RAR window configuration associated with the candidate cell.

Aspect 16: The method of aspect 14, wherein the first RACH configuration and the second RACH configuration are included within a same PRACH configuration associated with the candidate cell, the first RACH configuration comprises a first RACH parameter configuration associated with the candidate cell and a first RAR window configuration associated with the candidate cell, the first RAR window configuration indicating an exclusion of a RAR window associated with the first RACH configuration, and the second RACH configuration comprises a second RACH parameter configuration associated with the candidate cell and a second RAR window configuration associated with the candidate cell.

Aspect 17: The method of aspect 14, wherein the first RACH configuration and the second RACH configuration are included within a same PRACH configuration associated with the candidate cell and a same RACH parameter configuration associated with the candidate cell, the first RACH configuration comprises a first RAR window configuration associated with the candidate cell, the first RAR window configuration indicating an exclusion of a RAR window associated with the first RACH configuration, and the second RACH configuration comprises a second RAR window configuration associated with the candidate cell.

Aspect 18: The method of any of aspects 12 through 13, wherein the first RACH configuration and the second RACH configuration are included within a RACH configuration associated with the candidate cell, the first RACH configuration comprises a first RAR window configuration associated with the candidate cell, the first RAR window configuration indicating an exclusion of a RAR window associated with the first RACH configuration, and the second RACH configuration comprises a second RAR window configuration associated with the candidate cell.

Aspect 19: The method of any of aspects 12 through 13, wherein the first RACH configuration is included within a RACH configuration associated with the serving cell and comprises a first RAR window configuration associated with the candidate cell, the first RAR window configuration indicating an exclusion of a RAR window associated with the first RACH configuration, and the second RACH configuration is included within a RACH configuration associated with the candidate cell and comprises a second RAR window configuration associated with the candidate cell.

Aspect 20: The method of any of aspects 12 through 19, wherein the first RACH configuration and the second RACH configuration comprise an identifier associated with the candidate cell.

Aspect 21: An apparatus for wireless communication, comprising a memory, transceiver, and at least one processor of a UE, the at least one processor coupled with the memory and the transceiver and configured to perform a method of any of aspects 1 through 11.

Aspect 22: An apparatus for wireless communication at a UE, comprising at least one means for performing a method of any of aspects 1 through 11.

Aspect 23: A non-transitory computer-readable medium storing code for wireless communication at a UE, the code comprising instructions executable by a processor to perform a method of any of aspects 1 through 11.

Aspect 24: An apparatus for wireless communication, comprising a memory and at least one processor of a network entity, the at least one processor coupled with the memory and configured to perform a method of any of aspects 12 through 20.

Aspect 25: An apparatus for wireless communication at a network entity, comprising at least one means for performing a method of any of aspects 12 through 20.

Aspect 26: A non-transitory computer-readable medium storing code for wireless communication at a network entity, the code comprising instructions executable by a processor to perform a method of any of aspects 12 through 20.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database, or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication, comprising:
memory;
a transceiver; and
at least one processor of a user equipment (UE), the at least one processor coupled with the memory and the transceiver and configured to cause the apparatus to:
receive, via the transceiver and via a serving cell associated with the UE, a first control message indicating a first random access channel configuration and a second random access channel configuration that are associated with a candidate cell, the first random access channel configuration for the UE to use to communicate via the candidate cell before a switch to the candidate cell, the second random access channel configuration for the UE to use to communicate via the candidate cell after the switch to the candidate cell;
receive, via the transceiver, a second control message indicating that the UE is to perform a random access channel procedure to obtain timing advance information associated with the candidate cell;
transmit, via the transceiver before the switch to the candidate cell and based at least in part on the second control message, a first random access channel message via the candidate cell in accordance with the first random access channel configuration; and
transmit, via the transceiver after performing the switch to the candidate cell and based at least in part on the timing advance information, a second random access channel message via the candidate cell in accordance with the second random access channel configuration.

2. The apparatus of claim 1, the at least one processor further configured to cause the apparatus to:
receive, via the transceiver and via the serving cell or the candidate cell, a third control message indicating that the UE is to perform the switch to the candidate cell, the third control message indicating the timing advance information associated with the candidate cell.

3. The apparatus of claim 1, the at least one processor further configured to cause the apparatus to:
perform the switch to the candidate cell after transmitting the first random access channel message and before transmitting the second random access channel message, wherein the second random access channel message is communicated in accordance with the second random access channel configuration based at least in part on performing the switch.

4. The apparatus of claim 1, wherein the first random access channel configuration and the second random access channel configuration are included within a random access channel configuration associated with the serving cell.

5. The apparatus of claim 4, wherein:
the first random access channel configuration comprises a first physical random access channel configuration associated with the candidate cell, a first random access channel parameter configuration associated with the candidate cell, and a first random access response window configuration associated with the candidate cell, the first random access response window configuration indicating an exclusion of a random access response window associated with the first random access channel message, and
the second random access channel configuration comprises a second physical random access channel configuration associated with the candidate cell, a second random access channel parameter configuration associated with the candidate cell, and a second random access response window configuration associated with the candidate cell.

6. The apparatus of claim 4, wherein:
the first random access channel configuration and the second random access channel configuration are included within a same physical random access channel configuration associated with the candidate cell,
the first random access channel configuration comprises a first random access channel parameter configuration associated with the candidate cell and a first random access response window configuration associated with the candidate cell, the first random access response window configuration indicating an exclusion of a random access response window associated with the first random access channel message, and
the second random access channel configuration comprises a second random access channel parameter configuration associated with the candidate cell and a second random access response window configuration associated with the candidate cell.

7. The apparatus of claim 4, wherein:
the first random access channel configuration and the second random access channel configuration are included within a same physical random access channel configuration associated with the candidate cell and a same random access channel parameter configuration associated with the candidate cell,
the first random access channel configuration comprises a first random access response window configuration associated with the candidate cell, the first random access response window configuration indicating an exclusion of a random access response window associated with the first random access channel message, and
the second random access channel configuration comprises a second random access response window configuration associated with the candidate cell.

8. The apparatus of claim 1, wherein:
the first random access channel configuration and the second random access channel configuration are included within a random access channel configuration associated with the candidate cell,
the first random access channel configuration comprises a first random access response window configuration associated with the candidate cell, the first random access response window configuration indicating an exclusion of a random access response window associated with the first random access channel message, and
the second random access channel configuration comprises a second random access response window configuration associated with the candidate cell.

9. The apparatus of claim 1, wherein:
the first random access channel configuration is included within a random access channel configuration associated with the serving cell and comprises a first random access response window configuration associated with the candidate cell, the first random access response window configuration indicating an exclusion of a random access response window associated with the first random access channel message, and
the second random access channel configuration is included within a random access channel configuration associated with the candidate cell and comprises a second random access response window configuration associated with the candidate cell.

10. The apparatus of claim 1, wherein, to receive the second control message, the at least one processor is configured to cause the apparatus to:
receive the second control message via the serving cell or via the candidate cell.

11. The apparatus of claim 1, wherein the first random access channel configuration and the second random access channel configuration comprise an identifier associated with the candidate cell.

12. An apparatus for wireless communication, comprising:
memory; and
at least one processor of a network entity, the at least one processor coupled with the memory and configured to cause the apparatus to:
transmit, via a serving cell associated with a user equipment (UE), a first control message indicating a first random access channel configuration and a second random access channel configuration that are associated with a candidate cell, the first random access channel configuration for the UE to use to communicate via the candidate cell before a switch to the candidate cell, the second random access channel configuration for the UE to use to communicate via the candidate cell after the switch to the candidate cell; and
transmit, via the serving cell, a second control message indicating that the UE is to perform, based at least in part on the first random access channel configuration, a random access channel procedure to obtain timing advance information associated with the candidate cell.

13. The apparatus of claim 12, the at least one processor further configured to cause the apparatus to:
transmit, via the serving cell, a third control message indicating that the UE is to perform, based at least in part on the second random access channel configuration, the switch to the candidate cell, the third control message indicating the timing advance information associated with the candidate cell.

14. The apparatus of claim 12, wherein the first random access channel configuration and the second random access channel configuration are included within a random access channel configuration associated with the serving cell.

15. The apparatus of claim 14, wherein:
the first random access channel configuration comprises a first physical random access channel configuration associated with the candidate cell, a first random access channel parameter configuration associated with the candidate cell, and a first random access response window configuration associated with the candidate cell, the first random access response window configuration indicating an exclusion of a random access response window associated with the first random access channel configuration, and
the second random access channel configuration comprises a second physical random access channel configuration associated with the candidate cell, a second random access channel parameter configuration associated with the candidate cell, and a second random access response window configuration associated with the candidate cell.

16. The apparatus of claim 14, wherein:
the first random access channel configuration and the second random access channel configuration are included within a same physical random access channel configuration associated with the candidate cell,
the first random access channel configuration comprises a first random access channel parameter configuration associated with the candidate cell and a first random access response window configuration associated with the candidate cell, the first random access response window configuration indicating an exclusion of a random access response window associated with the first random access channel configuration, and
the second random access channel configuration comprises a second random access channel parameter configuration associated with the candidate cell and a second random access response window configuration associated with the candidate cell.

17. The apparatus of claim 14, wherein:
the first random access channel configuration and the second random access channel configuration are included within a same physical random access channel configuration associated with the candidate cell and a same random access channel parameter configuration associated with the candidate cell,
the first random access channel configuration comprises a first random access response window configuration associated with the candidate cell, the first random access response window configuration indicating an exclusion of a random access response window associated with the first random access channel configuration, and
the second random access channel configuration comprises a second random access response window configuration associated with the candidate cell.

18. The apparatus of claim 12, wherein:
the first random access channel configuration and the second random access channel configuration are included within a random access channel configuration associated with the candidate cell,
the first random access channel configuration comprises a first random access response window configuration associated with the candidate cell, the first random access response window configuration indicating an exclusion of a random access response window associated with the first random access channel configuration, and
the second random access channel configuration comprises a second random access response window configuration associated with the candidate cell.

19. The apparatus of claim 12, wherein:
the first random access channel configuration is included within a random access channel configuration associated with the serving cell and comprises a first random access response window configuration associated with the candidate cell, the first random access response window configuration indicating an exclusion of a random access response window associated with the first random access channel configuration, and
the second random access channel configuration is included within a random access channel configuration associated with the candidate cell and comprises a second random access response window configuration associated with the candidate cell.

20. A method for wireless communication at a user equipment (UE), comprising:
receiving, via a serving cell associated with the UE, a first control message indicating a first random access channel configuration and a second random access channel configuration that are associated with a candidate cell, the first random access channel configuration for the UE to use to communicate via the candidate cell before a switch to the candidate cell, the second random access channel configuration for the UE to use to communicate via the candidate cell after the switch to the candidate cell;
receiving a second control message indicating that the UE is to perform a random access channel procedure to obtain timing advance information associated with the candidate cell;
transmitting, before the switch to the candidate cell and based at least in part on the second control message, a first random access channel message via the candidate cell in accordance with the first random access channel configuration; and
transmitting, after performing the switch to the candidate cell and based at least in part on the timing advance information, a second random access channel message via the candidate cell in accordance with the second random access channel configuration.
